(19) United States
(12) Patent Application Publication
(10) Pub. No.: US 2021/0364987 A1
(43) Pub. Date: Nov. 25, 2021

(54) SYSTEM AND METHOD FOR HOLOGRAPHIC WAVE-FRONT PRINTING

(71) Applicant: Facebook Technologies, LLC, Menlo Park, CA (US)

(72) Inventors: Gang LI, Bothell, WA (US); Kiseung BANG, Seoul (KR); Andrew MAIMONE, Duvall, WA (US); Changwon JANG, Bellevue, WA (US); Mengfei WANG, Seattle, WA (US); Afsoon JAMALI, Redmond, WA (US); Junren WANG, Redmond, WA (US)

(21) Appl. No.: 16/878,018

(22) Filed: May 19, 2020

(51) Int. Cl. G03H 1/04; G03H 1/02; G03H 1/22; G02B 5/32

(52) U.S. Cl. CPC G03H 1/0404; G03H 1/0248; G03H 1/2294; G03H 1/0476; G03H 1/2205; G02B 5/32; G03H 2223/19; G03H 2222/31; G03H 2001/0495; G03H 2001/2207; G03H 2001/026; G03H 2223/20; G03H 2210/22

(57) ABSTRACT

A holographic recording system includes a linear translation stage configured to position a holographic material layer, a light source configured to emit a laser beam, a beam splitting subsystem configured to split the laser beam into a first light beam and a second light beam and direct the second light beam towards the holographic material layer, a spatial-light modulator configured to implement a fringe pattern that modulates the first light beam to generate an object beam, a filter configured to filter the object beam, a demagnification optical subsystem configured to demagnify the object beam, and a switchable grating stack configurable to direct the object beam to a set of directions towards the holographic material layer to interfere with the second light beam. In some embodiments, the switchable grating stack includes a plurality of polarization gratings and/or a plurality of switchable waveplates arranged in a stack.

### BACKGROUND

Holographic recording generally uses a signal wave (e.g., from or representing an object to be recorded or encoded) and a reference wave to generate an interference pattern in a recording material to record a holographic optical element (HOE), such as a hologram. Thus, a hologram can encode both the amplitude and phase information of an optical field from an object or scene, whereas a photograph may generally only record the two-dimensional (2D) amplitude of the optical field. When the HOE is illustrated using the reference wave, the HOE may diffract the reference wave to reproduce the signal wave, thus reconstructing the optical field of the object or scene. Holographic techniques can be used in many fields, such as three-dimensional (3D) display, optical metrology, medicine, commerce, and the like.

### SUMMARY

This disclosure relates generally to holographic optical elements. More specifically, disclosed herein are techniques for recording large holographic optical elements that can reproduce complex, freeform wave-fronts. Various inventive embodiments are described herein, including systems, subsystems, modules, devices, components, materials, methods, compositions, processes, and the like.

According to certain embodiments, a holographic recording system may include a linear translation stage configured to position a holographic material layer; a light source configured to emit a laser beam; a beam splitting subsystem configured to split the laser beam into a first light beam and a second light beam and direct the second light beam towards the holographic material layer; a spatial-light modulator configured to implement a fringe pattern that modulates the first light beam to generate an object beam; a demagnification optical subsystem configured to demagnify the object beam; and a switchable grating stack configurable to direct the object beam to a set of directions towards the holographic material layer to interfere with the second light beam.

In some embodiments of the holographic recording system, the object beam may be characterized by a freeform wave-front. The fringe pattern may include a computer-generated hologram. The fringe pattern may be configured to modulate at least one of a phase or an amplitude of the first light beam. In some embodiments, the holographic recording system may also include a lens positioned with respect to the spatial-light modulator such that the spatial-light modulator is at a focal plane of the lens, and a low-pass filter positioned at another focal plane of the lens and configured to filter the object beam. In some embodiments, the demagnification optical subsystem may be a telecentric subsystem that includes two lenses characterized by different respective focal lengths. In some embodiments, the set of directions may include at least a direction characterized by an angle greater than 300 with respect to a surface normal direction of the switchable grating stack.

In some embodiments of the holographic recording system, the switchable grating stack may include a plurality of polarization gratings arranged in a stack. Each polarization grating in the plurality of polarization gratings may be configurable to direct a right-handed circularly polarized light beam to a first direction and direct a left-handed circularly polarized light beam to a second direction. The plurality of polarization gratings may include at least one of a right-handed circular polarization grating or a left-handed circular polarization grating. The plurality of polarization gratings may include at least one of a polarization volume grating, a passive Pancharatnam-Berry phase (PBP) grating, or an active PBP grating. In some embodiments, each polarization grating in the plurality of polarization gratings may be configurable to diffract the right-handed circularly polarized light beam to one of ±1 diffraction orders, and diffract the left-handed circularly polarized light beam to another one of the ±1 diffraction orders. In some embodiments, each polarization grating in the plurality of polarization gratings is configured to diffract one of the right-handed circularly polarized light beam and the right-handed circularly polarized light beam to one of ±1 diffraction orders, and maintain a propagation direction of another one of the right-handed circularly polarized light beam and the right-handed circularly polarized light beam. In some embodiments, the holographic recording system may also include a plurality of switchable half-wave plates interleaved with the plurality of polarization gratings, where each of the plurality of switchable half-wave plates may be configured to convert a right-handed circularly polarized input beam into a left-handed circularly polarized output beam and convert a left-handed circularly polarized input beam into a right-handed circularly polarized beam when switched on, and, maintain a polarization state of an input beam when switched off by a voltage signal. Each polarization grating in the plurality of polarization gratings may be characterized by a different respective grating period.

In some embodiments, the holographic recording system may also include a second spatial-light modulator configured to implement a second fringe pattern that modulates the second light beam, and a second demagnification optical subsystem configured to demagnify the second light beam and direct the second light beam towards the holographic material layer. In some embodiments, the holographic recording system may also include a lens positioned with respect to the second spatial-light modulator such that the second spatial-light modulator is at a focal plane of the lens, and a low-pass filter positioned at another focal plane of the lens and configured to filter the second light beam.

According to certain embodiments, a method of recording of a hologram element of a plurality of hologram elements of a hologram may include controlling a linear translation stage to position a holographic material layer on the linear translation stage to a first position; providing data for implementing a fringe pattern to a spatial-light modulator, where the fringe pattern, when illuminated by a collimated light beam, may generate an object beam; filtering the object beam; demagnifying the object beam; configuring a switchable grating stack to steer the object beam to a direction of a set of discrete directions; and exposing an area of the holographic material layer to the object beam and a reference beam to form the hologram element.

In some embodiments, the method may also include providing data for implementing a second fringe pattern to a second spatial-light modulator, where the second fringe pattern, when illuminated by a second collimated light beam, may generate the reference beam; filtering the reference beam; and demagnifying the reference beam. In some embodiments, the switchable grating stack may include a plurality of polarization gratings and a plurality of switchable half-wave plates arranged in a stack. Each polarization grating in the plurality of polarization gratings may be configurable to direct a right-handed circularly polarized light beam to a first direction and direct a left-handed circularly polarized light beam to a second direction.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1A illustrates an example of a holographic recording system according to certain embodiments. FIG. 1B illustrates an example of recording a holographic optical element in a holographic material layer using an object wave and a reference wave.

FIG. 2 illustrates an example of a holographic recording material including two-stage photopolymers.

FIGS. 3A-3B illustrate an example of recording a holographic optical element in a photopolymer material layer. FIG. 3A illustrates an example of an unexposed photopolymer material layer. FIG. 3B illustrates an example of monomer diffusion and polymerization during the holographic recording in the photopolymer material layer.

FIG. 4 illustrates an example of a holographic printer for recording large holographic optical elements according to certain embodiments.

FIG. 5 illustrates an example of an optical subsystem of a holographic printer including a spatial-light modulator for generating freeform object waves to record large holographic optical elements according to certain embodiments.

FIG. 6 includes a simplified block diagram of an example of a holographic wave-front printer including a spatial-light modulator for generating freeform object waves to record large holographic optical elements according to certain embodiments.

FIG. 7A illustrates examples of desired wave-fronts of object waves for recording holographic optical elements in a holographic material layer. FIG. 7B illustrates examples of object waves generated by an optical subsystem of a holographic printer for recording the holographic optical elements of FIG. 7A.

FIG. 8A illustrates an example of a method for generating desired object waves for recording holographic optical elements. FIG. 8B illustrates examples of computer-generated holograms for generating the desired object waves for recording holographic optical elements.

FIG. 9A illustrates an example of a fringe pattern implemented using a spatial-light modulator for generating a desired object wave to record a holographic optical element, and the Fourier spectra of the fringe pattern on a Fourier plane. FIG. 9B illustrates an example of a fringe pattern implemented using a spatial-light modulator for generating a desired object wave to record a holographic optical element, and the Fourier spectra of the fringe pattern on a Fourier plane. FIG. 9C illustrates an example of a fringe pattern implemented using a spatial-light modulator for generating a desired object wave to record a holographic optical element, and the Fourier spectra of the fringe pattern on a Fourier plane.

FIG. 10A illustrates an example of a holographic wave-front recording system including a spatial-light modulator and a switchable grating stack according to certain embodiments. FIG. 10B illustrates examples of fringe patterns implemented using a spatial-light modulator for generating desired object waves to record holographic optical elements, and the Fourier spectra of the fringe patterns on a Fourier plane according to certain embodiments.

FIG. 11 illustrates an example of a beam steering device including a switchable grating stack for steering an object beam to a large angular range according to certain embodiments.

FIG. 12 includes a diagram illustrating examples of object beam steering by the switchable grating stack shown in FIG. 11 according to certain embodiments.

FIGS. 13A-13D illustrate operations of examples of polarization volume gratings according to certain embodiments. FIG. 13A illustrates the operation of a right-handed polarization volume grating on incident light having the right-handed circular polarization. FIG. 13B illustrates the operation of the right-handed polarization volume grating on incident light having the left-handed circular polarization. FIG. 13C illustrates the operation of a left-handed polarization volume grating on incident light having the right-handed circular polarization. FIG. 13D illustrates the operation of the left-handed polarization volume grating on incident light having the left-handed circular polarization.

FIG. 14A is a top view of an example of a switchable Pancharatnam-Berry phase (PBP) grating according to certain embodiments. FIG. 14B is a side view of the example of the switchable PBP grating shown in FIG. 14A according to certain embodiments. FIG. 14C is a top view of the example of the switchable PBP grating that is switched off according to certain embodiments.

FIGS. 15A-15C illustrate operations of an example of a switchable PBP grating according to certain embodiments. FIG. 15A illustrates an example of the diffraction of a right-handed circularly polarized incident light beam by the switchable PBP grating in an “ON” state.

FIG. 15B illustrates an example of the diffraction of a left-handed circularly polarized incident light beam by the switchable PBP grating in the “ON” state. FIG. 15C illustrates an example of the transmission of incident light beam by the switchable PBP grating in the “OFF” state.

FIGS. 16A-16C illustrate operations of an example of a switchable PBP grating according to certain embodiments. FIG. 16A illustrates an example of the diffraction of a right-handed circularly polarized incident light beam by the switchable PBP grating in an “ON” state.

FIG. 16B illustrates an example of the diffraction of a left-handed circularly polarized incident light beam by the switchable PBP grating in the “ON” state. FIG. 16C illustrates an example of the transmission of incident light beam by the switchable PBP grating in the “OFF” state.

FIG. 17A illustrates an example of an operation of a switchable grating stack according to certain embodiments. FIG. 17B illustrates an example of an operation of the switchable grating stack of FIG. 17A according to certain embodiments.

FIG. 18A illustrates an example of an operation of a switchable grating stack according to certain embodiments. FIG. 18B illustrates an example of an operation of the switchable grating stack of FIG. 18A according to certain embodiments.

FIG. 19 includes a simplified block diagram of an example of a holographic printer according to certain embodiments.

FIG. 20 is a simplified flowchart illustrating an example of a method of printing a holographic optical element according to certain embodiments.

FIG. 21 is a simplified block diagram of an example of a display system environment including a near-eye display according to certain embodiments.

FIG. 22 illustrates an example of a computer system for implementing some of the embodiments disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Techniques disclosed herein relate generally to holographic optical elements. More specifically, and without limitation, disclosed herein are techniques for fabricating holographic optical elements having high spatial frequencies using holographic wave-front recording processes. Various inventive embodiments are described herein, including systems, subsystems, modules, devices, components, methods, processes, compositions, materials, and the like.

Many existing three-dimensional (3D) displays imitate 3D objects or scenes by separately displaying different perspective images of the 3D objects or scenes to the two eyes of a viewer, rather than reproducing the original light waves from the 3D objects or scenes to be displayed. Holograms, on the other hand, can reproduce the original light waves from the 3D objects or scenes. Holograms or other holographic optical elements (HOEs) are generally recorded using a signal wave (e.g., the optical wave from an object, also referred to as an object wave or an object beam) and a reference wave to generate an interference pattern in a recording material. In many applications, freeform wave-front recording may be needed to record a holographic optical element that can reconstruct an optical field with an arbitrary, complex wave-front. Signal waves with the desired freeform wave-fronts may be difficult to generate using conventional optics, such as spherical lenses, cylindrical lenses, and prisms. In some holographic printing systems, a spatial-light modulator (SLM) may be used to generate the signal wave with at least a portion of the desired wave-front. The signal wave may be filtered (e.g., using a DC filter to remove zeroth-order diffraction (DC) component and using a low-pass filter to remove high-order diffraction components), and then relayed and demagnified (e.g., to improve the lateral resolution) through, for example, a 4-f system, to form a hologram element (often referred to as a hogel) in a holographic recording material layer. The holographic recording material layer or the recording system may be moved to a different position to record a next hologram element with a modified signal wave. In this way, a large hologram including many hologram elements for large display size and large view angle ranges may be recorded by scanning the holographic recording material layer or the recording system.

In some applications, such as some 3D display systems, HOEs having high spatial frequencies (and thus high resolutions in displayed images), large viewable angle ranges in the reconstructed optical fields (and thus a large field of view), and high diffraction efficiencies (and thus high brightness in the displayed images) may be used. It may be difficult to record such a large HOE using existing holographic printing techniques due to, for example, the limited resolution or spatial frequency bandwidth (and full-color capability) of the SLMs.

According to certain embodiments, a beam steering device may be used in a holographic printing system to record large HOEs that can diffract light with large diffraction angles at high efficiencies. An SLM may be used to generate an object beam with fundamental spatial frequencies, and the beam steering device may be used to tilt the object beam generated by the SLM by different tilting angles. The beam steering device may have a variable carrier spatial frequency for shifting the fundamental spatial frequencies generated by the SLM to higher frequencies (e.g., the sum of the spatial frequencies of the SLM and the spatial frequency of the beam steering device). In other words, the desired SLM with high spatial frequencies may be achieved by the combination of the SLM with lower spatial frequencies and the beam steering device. In this way, large HOEs with large diffraction angles and high diffraction efficiencies can be recorded using the SLM having a lower resolution or spatial frequency bandwidth. In some embodiments, the reference beam may also be modulated by an SLM and/or tilted by a beam steering device. In some embodiments, the object beam and the reference beam may be demagnified to record small hologram elements.

The beam steering device can be implemented using, for example, switchable Bragg gratings, Pancharatnam-Berry Phase (PBP) gratings, polarization volume gratings, liquid crystal gratings, SLMs, optical phased arrays, and the like. In one example, the beam steering device may include a stack of PBP gratings, where each PBP grating may be configured to tilt incident light by different respective angles, and thus different overall tilt angles can be achieved by different configuration of the individual PBP gratings in the stack. In some embodiments, the PBP gratings may be active gratings that can be switched on or off. In some embodiments, the beam steering device may include one or more switchable polarization converters interleaved with the PBP gratings, where the switchable polarization converters may be used to set the polarization states of the input beams incident on the PBP gratings.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

A hologram can encode both the amplitude and phase information of an optical field, whereas a photograph may generally only record the two-dimensional (2D) amplitude of the optical field. To generate the desired light interference pattern for recording HOEs, at least two coherent beams may generally be used, where one beam may be a reference beam and another beam may be an object beam that may have the desired wave-front of an object or scene to be recorded. When the recorded HOEs are illuminated by the reference beam, the object beam with the desired wave-front may be reconstructed. Holographic techniques may be used in many fields. For example, holographic printing techniques can be used to record 3D objects and scenes in holograms, where the light fields from the 3D objects and scenes can be reconstructed when the holograms are illuminated by, for example, white light, such that the 3D objects and scenes may be viewed by a viewer from different perspectives.

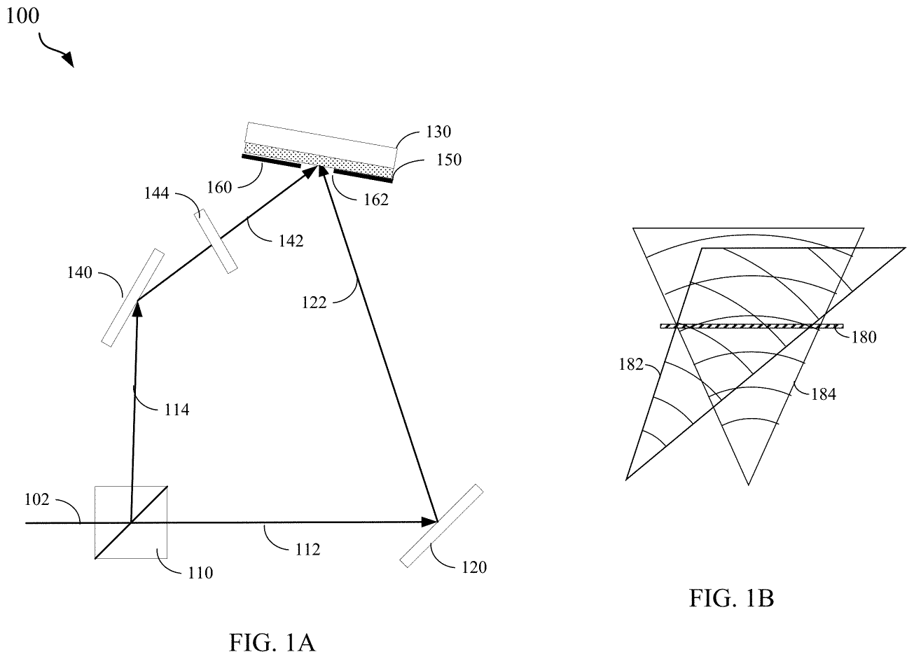

FIG. 1A illustrates an example of a holographic recording system 100 for recording holographic optical elements. Holographic recording system 100 includes a beam splitter 110 (e.g., a polarization beam splitter cube), which may split an incident collimated laser beam 102 into two light beams 112 and 114 that are coherent and have similar intensities. Light beam 112 may be reflected by a first mirror 120 towards a plate 130 as shown by the reflected light beam 122. On another path, light beam 114 may be reflected by a second mirror 140. The reflected light beam may be directed to an object 144 (e.g., an object to be recorded or an SLM) to illuminate object 144. A light beam 142 from object 144 may be directed towards plate 130, and may interfere with light beam 122 at plate 130 to generate an interference pattern that may include bright fringes and dark fringes. A holographic recording material layer 150 may be formed on plate 130 or on a substrate mounted on plate 130. The interference pattern may cause the holographic optical element to be recorded in holographic recording material layer 150 as described above.

In some embodiments, a mask 160 may be used to record different HOEs at different regions of holographic recording material layer 150. For example, mask 160 may include an aperture 162 for the holographic recording and may be moved to place aperture 162 at different regions on holographic recording material layer 150 to record different HOEs at the different regions under different recording conditions (e.g., recording beams with different angles or different wave-fronts).

FIG. 1B illustrates an example of recording a holographic optical element in a holographic material layer 180 using an object beam 182 (e.g., light beam 142) and a reference beam 184 (e.g., light beam 122). Object beam 182 and reference beam 184 may be coherent, such as from a same laser source. Object beam 182 may have an arbitrary wavefront representing an object or scene to be recorded. For example, to record a lens, the wave-front of object beam 182 may be a spherical. To record a virtual object, object beam 182 may be a beam diffracted by a computer-generated hologram (CGH). Reference beam 184 may be, for example, a plane wave, or may have a wave-front that is not flat. Because object beam 182 and reference beam 184 are coherent, they may interfere with each other to generate a desired optical fringe pattern (e.g., bright and dark fringes) at holographic material layer 180. The optical fringe pattern may generate a unique refractive index modulation pattern at the photosensitive holographic material layer 180, where the refractive index modulation pattern may correspond to the optical fringe pattern.

The photosensitive material layer may include, for example, silver halide emulsion, dichromated gelatin, photopolymers including photo-polymerizable monomers suspended in a polymer matrix, photorefractive crystals, and the like. The holographic recording materials in the photosensitive holographic material layer (e.g., holographic recording material layer 150 or holographic material layer 180) can be selected for specific applications based on some parameters of the holographic recording materials, such as the spatial frequency response, dynamic range, photosensitivity, physical dimensions, mechanical properties, wavelength sensitivity, and development or bleaching method for the holographic recording material.

The dynamic range indicates the refractive index change that can be achieved in a holographic recording material. The dynamic range may affect, for example, the thickness of the device to achieve a high efficiency, and the number of holograms that can be multiplexed in a holographic material layer. The dynamic range may be represented by the refractive index modulation, which may be one half of the total change in refractive index. In generally, a large refractive index modulation in the holographic optical elements is desired in order to improve the diffraction efficiency and record multiple holographic optical elements in a same holographic material layer. However, for holographic photopolymer materials, due to the solubility limitation of the monomers in the holographic photopolymer materials, the maximum achievable refractive index modulation or dynamic range may be limited.

The spatial frequency response is a measure of the feature size that the holographic material can record and may dictate the types of Bragg conditions that can be achieved. The spatial frequency response can be characterized by a modulation transfer function, which may be a curve depicting the sinusoidal waves of varying frequencies. In general, a single spatial frequency value may be used to represent the frequency response, which may indicate the spatial frequency value at which the refractive index modulation begins to drop or at which the refractive index modulation is reduced by 3 dB. The spatial frequency response may also be represented by lines/mm, line pairs/mm, or the period of the sinusoid.

The photosensitivity of the holographic recording material may indicate the photo-dosage used to achieve a certain efficiency, such as 100% (or 1% for photo-refractive crystals). The physical dimensions that can be achieved in a particular holographic material may affect the aperture size as well as the spectral selectivity of the HOE device. Physical parameters of holographic recording materials may include, for example, damage thresholds and environmental stability. The wavelength sensitivity may be used to select the light source for the recording setup and may also affect the minimum achievable period. Some materials may be sensitive to light in a wide wavelength range. Many holographic materials may need post-exposure development or bleaching. Development considerations may include how the holographic material is developed or otherwise processed after the recording.

To record holographic optical elements for an artificial reality system, it may be desirable that the holographic material is sensitive to visible light, can produce a large refractive index modulation Δn (e.g., high dynamic range), and have temporally and spatially controllable reaction and/or diffusion of the monomers and/or polymers such that chain transfer and termination reactions can be suppressed. One example of the holographic material layer for holographic recording is two-stage photopolymers.

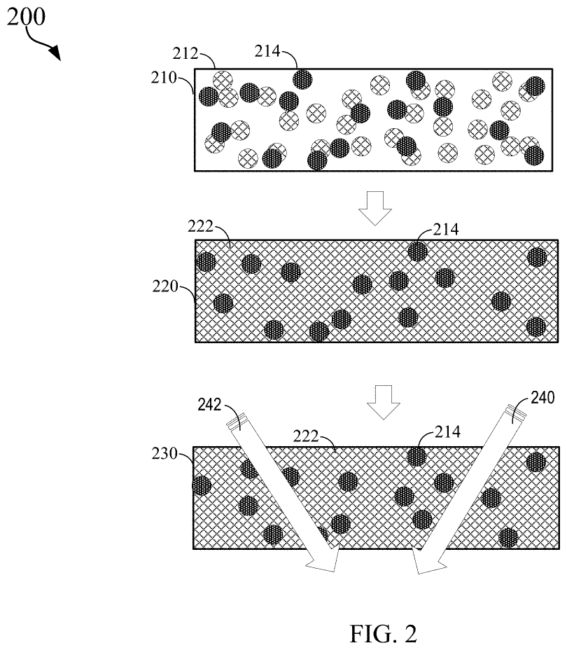

FIG. 2 illustrates an example of a holographic recording material including two-stage photopolymers. The raw material 210 of the two-stage photopolymers may be a resin including matrix precursors 212 and imaging components 214. Matrix precursors 212 in raw material 210 may include monomers that may be thermally or otherwise cured at the first stage to polymerize and to form a photopolymer film 220 that includes a cross-linked matrix formed by polymeric binders 222. Imaging components 214 may include writing monomers and polymerization initiating agents, such as photosensitizing dyes, initiators, and/or chain transfer agents. Thus, photopolymer film 220 may include polymeric binders 222, writing monomers (e.g., acrylate monomers), and initiating agents, such as photosensitizing dyes, initiators, and/or chain transfer agents. Polymeric binders 222 may act as the backbone or the support matrix for the writing monomers and initiating agents. For example, in some embodiments, polymeric binders 222 may include a low refractive index (e.g., <1.5) rubbery polymer (e.g., a polyurethane), which may provide mechanical support during the holographic exposure and ensure the refractive index modulation by the light pattern is permanently preserved.

Imaging components 214 including the writing monomers and the polymerization initiating agents may be dispersed in the support matrix. The writing monomers may serve as refractive index modulators. For example, the writing monomers may include high refractive index acrylate monomers which can react with the initiators and polymerize. The photosensitizing dyes may be used to absorb light and interact with the initiators to produce active species, such as radicals, cations (e.g., acids), or anion (e.g., bases). The active species (e.g., radicals) may initiate the polymerization by attacking a monomer. For example, in some monomers, one electron pair may be held securely between two carbons in a sigma bond and another electron pair may be more loosely held in a pi bond, and the free radical may use one electron from the pi bond to form a more stable bond with a first carbon atom in the two carbon atoms. The other electron from the pi bond may return to the second carbon atom in the two carbon atoms and turn the whole molecule into another radical. Thus, a monomer chain (e.g., a polymer) may be formed by adding additional monomers to the end of the monomer chain and transferring the radical to the end of the monomer chain to attack and add more monomers to the chain.

During the recording process (e.g., the second stage), an interference pattern generated by the interference between two coherent beams 240 and 242 may cause the photosensitizing dyes and the initiators in the bright fringes to generate active species, such as radicals, cations (e.g., acids), or anion (e.g., bases), from the initiators, where the active species (e.g., radicals) may transfer from the initiators to monomers and cause the polymerization of the monomers in the bright fringes as described above. The initiators or radicals may be bound to the polymer matrix when abstracting the hydrogen atoms on the polymer matrix. The radicals may be transferred to the ends of the chains of monomers to add more monomers to the chains. While the monomers in the bright fringes are attached to chains of monomers, monomers in the unexposed dark regions may diffuse to the bright fringes to enhance the polymerization. As a result, polymerization concentration and density gradients may be formed in photopolymer film 220, resulting in refractive index modulation in photopolymer film 220 due to the higher refractive index of the writing monomers. For example, areas with a higher concentration of monomers and polymerization may have a higher refractive index. Thus, a hologram or a holographic optical element 230 may be formed in photopolymer film 220.

During the exposure, a radical at the end of one monomer chain may combine with a radical at the end of another monomer chain to form a longer chain and terminate the polymerization. In addition to the termination due to radical combination, the polymerization may also be terminated by disproportionation of polymers, where a hydrogen atom from one chain may be abstracted to another chain to generate a polymer with a terminal unsaturated group and a polymer with a terminal saturated group. The polymerization may also terminated due to interactions with impurities or inhibitors (e.g., oxygen). In addition, as the exposure and polymerization proceed, fewer monomers may be available for diffusion and polymerization, and thus the diffusion and polymerization may be suppressed. The polymerization may stop until there are no more monomers or until the monomer chains terminate for an exposure. After all or substantially all monomers have been polymerized, no more new holographic optical elements (e.g., gratings) may be recorded in photopolymer film 220.

In some embodiments, the recorded holographic optical elements in the photosensitive material layer may be UV cured or thermally cured or enhanced, for example, for dye bleaching, completing polymerization, permanently fixing the recorded pattern, and enhancing the refractive index modulation. At the end of the process, a holographic optical element, such as a holographic grating, may be formed. The holographic grating may be a volume Bragg grating with a thickness of, for example, a few, or tens, or hundreds of microns.

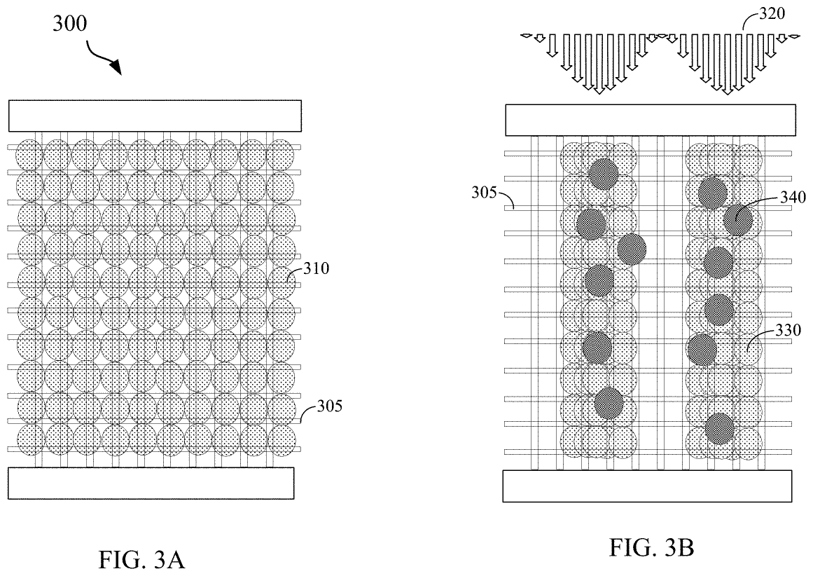

FIGS. 3A-3B illustrate an example of recording a holographic optical element in a photopolymer material layer 300. FIG. 3A illustrates the unexposed photopolymer material layer 300 that may include monomers 310 suspended in a resin that may include a supporting polymer matrix 305 (e.g., a cross-linked matrix formed by polymeric binders 222). Monomers 310 may be substantially evenly distributed within photopolymer material layer 300.

FIG. 3B illustrates an example of monomer diffusion and polymerization during holographic recording. When photopolymer material layer 300 is exposed to a light pattern 320, monomers 310 may diffuse to the bright fringes in photopolymer material layer 300 and polymerize to form polymers 330 and 340 in the bright fringes as described above. Some polymers, such as polymers 330 may be bound to polymer matrix 305. Some polymers, such as polymers 340, may not be bound to polymer matrix 305. As a result, polymerization concentration and density gradients may be formed in photopolymer material layer 300, resulting in refractive index modulation in photopolymer material layer 300 due to the higher refractive index of the writing monomers. Thus, areas with a higher concentration of monomers and polymerization may have a higher refractive index. In this way, light pattern 320 may be recorded in photopolymer material layer 300.

Holographic optical elements or holograms that can encode directional, color, and depth information from a 3D object or scene may be fabricated in holographic materials using holographic printers, such as holographic stereogram printers, holographic fringe printers, and holographic wave-front printers. In holographic printers, an object wave may need to be generated in order to interfere with a reference beam to form the light fringe pattern. It can be difficult to generate an arbitrary freeform wave-front using classical, physical optical components, such as spherical lenses, cylindrical lenses, prisms, and the like. Thus, in holographic printers, information to be recorded may generally be displayed by an SLM to generate the wave-front of numerically synthesized object wave. The holographic printer may then record the information provided by the SLM onto a light-sensitive holographic material in the way an analog hologram is recorded as described above.

A spatial-light modulator may modulate the intensity, phase, polarization state, and/or direction of an incident light wave. The modulation may be controlled by a control circuit that may apply control signals to individual addressable pixels of the SLM. Examples of SLMs may include a liquid-crystal-on-silicon (LCOS) SLM and a digital micro-mirror device (DMD). An LCOS SLM may generally have a smaller pixel pitch than a DMD SLM. In a phase SLM that includes an LCOS SLM, a liquid crystal layer on a silicon substrate may be controlled by voltage signals to perform the desired light modulation. An addressing circuit may be formed on the silicon substrate, and individual electrodes for the pixels may be formed on two sides of the liquid crystal layer. When an voltage signal is applied to the electrodes of a pixel, the electric field in the liquid crystal layer may cause the liquid crystal molecules to tilt by an angle that may correlate with the electric field, which may cause a change of the refractive index (and thus the optical path length) of the pixel. The change in the optical path length may change the phase of an optical beam passing through the SLM. Because the refractive index of the pixel may depend on the orientation of the liquid crystal molecules, which in turn may depend on the intensity and direction of the electric field, the phase delay of the pixel can be changed by changing the voltage signal applied to the pixel. For example, a pixel in the SLM may be controlled to have multiple levels of phase delay, such as two levels, 4 levels, 8 levels, 16 levels, or more levels.

The polarization state, the intensity, and the propagation direction of the incident light beam may also be changed by the change in the orientation of the liquid crystal molecules that may be controlled by the voltage signal applied to the pixel.

An SLM may have a certain number of individually controllable pixels (also referred to as cells) arranged in a 2D array that may have an area up to a few square inches. The pixels may each have a certain size. The pitch of the 2D array may range from less than a micron to a few microns, a few tens of microns, or larger. Thus, the total number of pixels, the resolution (e.g., the number of pixels in a unit area), and the maximum achievable spatial frequency (e.g., the number of periods or cycles in a unit length, e.g., 1/period) of an SLM may be limited.

An analog hologram recorded in holographic materials having nanometer-sized photosensitive particles can achieve a much higher resolution and spatial frequency than an SLM. Therefore, due to the limited size, resolution, and spatial frequency bandwidth of the SLM used for the holographic printing, a printed hologram may generally include a 2D array of hologram elements recorded through many exposures. The recording of the whole hologram may be done by successive exposures of the hologram elements using respective portions of the object wave generated by the SLM and a motorized 2D linear translation stage that may position holographic material layers in a 2D array of different locations.

A holographic stereogram printer can be used to print a holographic stereogram that is synthesized from an array of 2D perspective images. To make a holographic stereogram, a sequence of 2D images of an object or scene is incoherently acquired from multiple perspectives. The directional information carried by the perspective images is processed to form parallax-related images, which modulate the intensity of the signal wave of the object and, after displaying on a projection screen, are recorded onto a holographic photosensitive material by a coherent source in a two-beam recording scheme described above. The whole hologram may be divided into many hologram elements (referred to as hogels) that are sequentially exposed to the parallax-related images. Illumination of the fringe patterns recorded in the hologram can reconstruct the 3D object or scene by spatial multiplexing of the perspective views. Thus, a viewer's left and right eyes may observe different perspectives of the object or scene, such that the viewer may perceive stereoscopic vision due to the binocular parallax. The white light viewable holographic stereogram spatially multiplexes 2D images, and hence may not reconstruct a real 3D image.

The holographic stereogram printer can be used for quasi-3D visualization through space shifting of multiple hologram elements to improve the space bandwidth (SBP) and depth performance of a display system. The holographic stereogram printing can provide high resolution full parallax reconstruction from images of real or virtual objects captured by a camera or modeled using computer graphics. Computations to render only the directional information and the implementation using pulse laser sources may allow for printing large sized holograms. Thus, holographic stereogram printing may allow high-quality holographic quasi-3D imaging of large objects. Because the holographic stereogram technique is based on the recording of dense light-rays, the diffraction effect and the spatial/angular sampling of light-rays from a finite discrete set of viewpoints may cause degradation of the reconstructed quasi-3D images. The holographic stereogram printers generally employ the zeroth diffraction order of the light diffracted by the SLM.

Holographic fringe printers can directly print a computer-generated fringe pattern (e.g., CGH) of a 3D object or scene on a light sensitive material. The fringe pattern of the CGH may be calculated based on vigorous diffraction analysis, which can be time-consuming. A portion of the calculated fringe pattern may be displayed on an SLM, and a demagnified version of the portion of the fringe pattern may be recorded in a holographic material layer as a thin hologram element, which may need laser illumination for reconstruction. After the exposure, the holographic material layer may be shifted with a highly accurate 2D linear translation stage controlled by a stepping motor to record another hologram element. The resolution of the printed fringe pattern may depend on the quality of the SLM and the optics used to transfer the image from the SLM onto the holographic material layer. The SLMs used in holographic fringe printers may need to have high spatial resolutions in order to ensure large viewing angles.

A holographic wave-front printer records an object wave from a 3D object or scene or an object wave from a CGH (e.g., displayed by an SLM) as an analog volume hologram. Both the directional and the depth information of the object are recorded. Since the digitally designed wave-front of a target 3D object or scene is optically reproduced by the CGH and recorded on the hologram recording material, an arbitrary wave-front with full control of both amplitude and phase distribution can be recorded. Since an SLM device may not be able to display an entire hologram, the data for the hologram may be divided into a set of data for a set of hologram elements, and a wave-front for each hologram element is sequentially generated using the SLM and recorded on a region of the hologram recording material layer positioned by a motorized linear translation stage. The holographic wave-front printers generally use the first diffraction order of the light diffracted by the SLM.

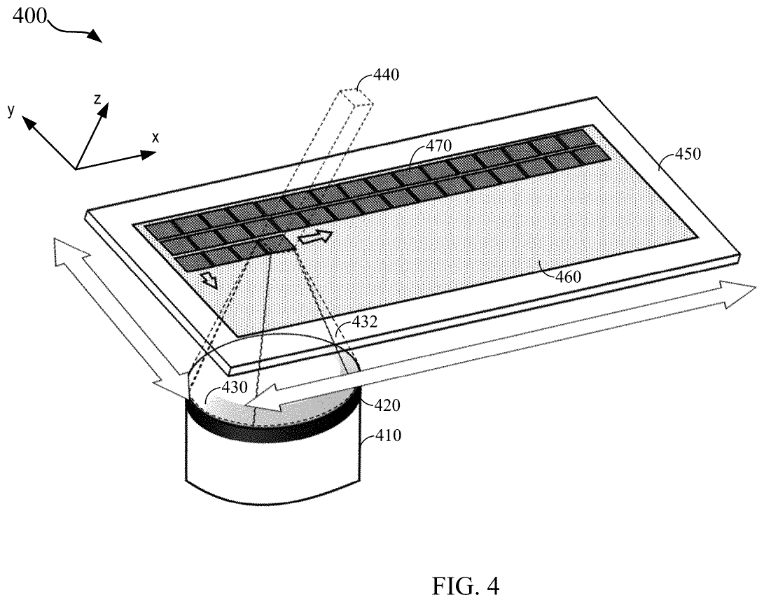

FIG. 4 illustrates an example of a holographic printer 400 for recording large holographic optical elements according to certain embodiments. Holographic printer 400 may be a holographic stereogram printer, a holographic fringe printer, or a holographic wave-front printer described above. For example, holographic printer 400 may be a holographic stereogram printer, where perspective images of an object or scene may be displayed on an SLM 420 that is illuminated by an expanded laser beam 410 and may be converged by an optical subsystem 430 (e.g., a lens) as an object beam 432 on a predefined area of a holographic material layer 460. The predefined area may determine the size of a hologram element 470 (often referred to as a hogel). A reference beam 440 is incident on the same area from the opposite side to generate a hologram element 470. Thus, information about the perspective images displayed on the SLM is recoded as an interference pattern formed by object beam 432 and reference beam 440 in hologram element 470. After one hologram element 470 is recorded, a motorized two-axis linear stage 450 may translate holographic material layer 460 in the x and/or y directions to the next recording position, and perspective images for the next hologram element may be displayed on the SLM for the next hologram element recording. The step of the translation of motorized two-axis linear stage 450 along each axis may be equal to or greater than the size of the hologram element.

In some embodiments, holographic printer 400 may be a holographic wave-front printer, where SLM 420 may display a CGH to generate object beam 432 that has a desired wave-front for recording a hologram element. The object beam 432 generated by SLM 420 may be demagnified and relayed onto holographic material layer 460 by optical subsystem 430.

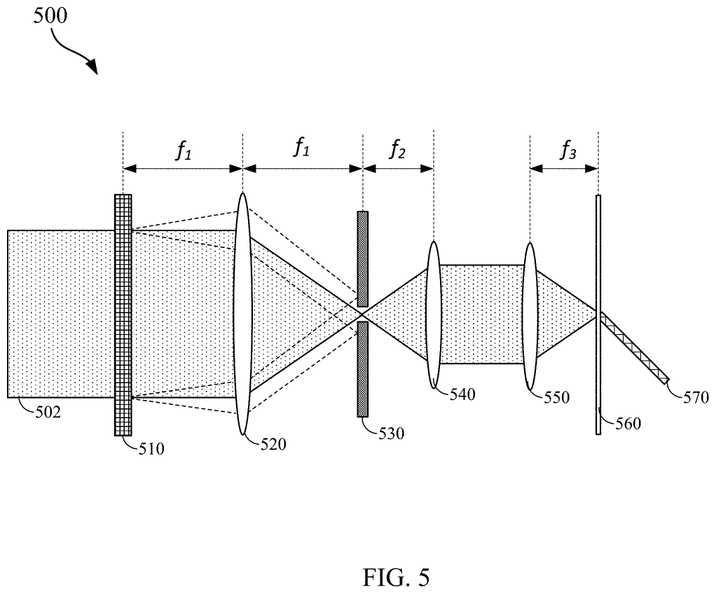

FIG. 5 illustrates an example of an optical subsystem 500 of a holographic printer including a spatial-light modulator 510 for generating freeform object waves to record large holographic optical elements according to certain embodiments. Optical subsystem 500 may be an example of a combination of SLM 420 and optical subsystem 430 of FIG. 4. In the illustrated example, optical subsystem 500 may include SLM 510, a first lens 520 that has a focal length f₁, a mask 530, a second lens 540 having a focal length f₂, and a third lens 550 having a focal length f₃. SLM 510 may be positioned at a distance f₁ on one side of first lens 520. Mask 530 may be positioned at a distance f₁ on another side of first lens 520 and may be at a distance f₂ from second lens 540. A holographic material layer 560 may be placed at a distance f₃ from third lens 550. The focal length f₂ of second lens 540 may be equal to or shorter than the focal length f₁ of first lens 520.

In a holographic stereogram printer, perspective images generated by SLM 510, when illuminated by a collimated beam 502, may be Fourier transformed by first lens 520 to the Fourier plane where mask 530 is located. After passing mask 530, the signal beam may be demagnified and relayed through second lens 540 and third lens 550 (e.g., forming 4-f optics) to holographic material layer 560, which may include, for example, photopolymers described above. On the plane of holographic material layer 560, the relayed signal beam may interfere with a reference beam 570 from an opposite side to form an interference pattern. Thus, the information on the SLM may be recorded on holographic material layer 560 that has a refractive index modulation corresponding to the interference pattern.

Mask 530 may include an aperture that is designed to set the size and shape of the hologram element. For example, the size of the hologram element may be smaller when the size of the aperture in mask 530 is smaller. Mask 530 may also perform spatial filtering of the Fourier spectra of the signal beam from SLM 510 because mask 530 is located at the Fourier plane. Mask 530 may function as a low-pass spatial filter that blocks high diffraction order components of the image displayed by SLM 510. As described above, in general, in a holographic stereogram printer, mask 530 may only allow the zeroth diffraction order of the light diffracted from the SLM 510 to pass. As a result, if the aperture in mask 530 is very small in order to achieve a small hogel, the perspective image displayed by SLM 510 may not be fully transferred to the holographic material layer, and thus a blurred image may be recorded. Thus, recording small-sized hogels to achieve a high lateral resolution of the holographic stereogram may cause loss of the high-frequency components of the perspective images, and thus may degrade the quality of the recorded images.

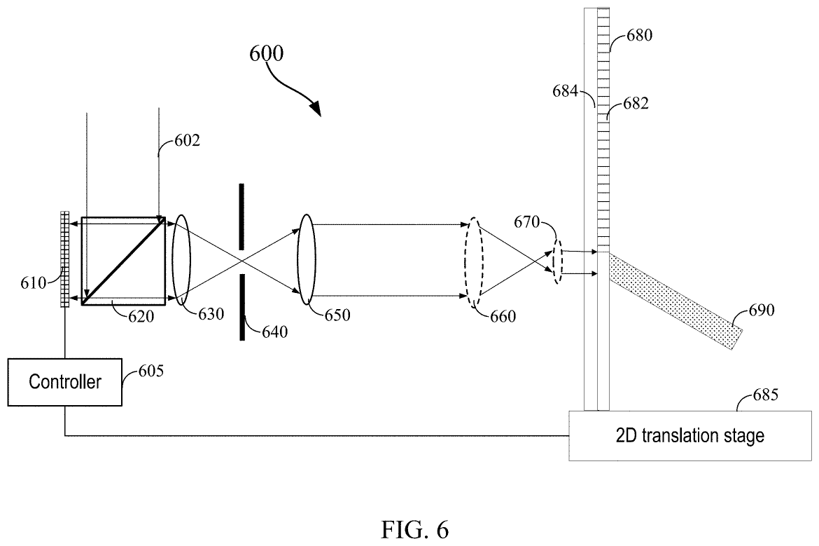

FIG. 6 includes a simplified block diagram of an example of a holographic wave-front printer 600 including a spatial-light modulator 610 for generating freeform object waves to record large holographic optical elements according to certain embodiments. In the illustrate example, holographic wave-front printer 600 may include an SLM 610, a controller 605 that controls SLM 610 to implement a desired CGH (e.g., a digitally designed HOE), a polarization beam splitter (PBS) 620, a first lens 630 having a first focal length f₁, a filter 640, a second lens 650 having a second focal length f₂, and optionally, a third lens 660 and a fourth lens 670. Holographic wave-front printer 600 may also include a motorized 2D translation stage 685 that may be driven by one or more step motors to position a plate 684 on which a holographic material layer 680 is formed. Holographic wave-front printer 600 may also include a controller 605 (e.g., a computer, a microcontroller, or other control circuit) that controls SLM 610 to implement the desired CGHs. In some embodiments, controller 605 may also control the operation of motorized 2D translation stage 685 or synchronize the operations of SLM 610 and motorized 2D translation stage 685. As described above, SLM 610 may not have the desired resolution, spatial frequency bandwidth, and number of pixels to reproduce the entire wave-front of the target object or scene. Thus, the data for the entire hologram may be divided into a set of data for a set of hologram elements, and the wave-front generated from the data for each hologram element may be recorded sequentially on different areas of holographic material layer 680 using motorized 2D translation stage 685.

During operations of holographic wave-front printer 600, a collimated object beam 602 (e.g., at about 532 nm) may be directed by PBS 620 to SLM 610. SLM 610 may receive data from controller 605 to implement a holographic fringe pattern (e.g., a CGH) corresponding to a hologram element. The object beam may be modulated by SLM 610 such that the modulated object beam may have a wave-front of a part of the optical field of the target 3D object or scene. The modulated object beam may be Fourier transformed by first lens 630. The undesired light, such as the high order diffraction waves and the unmodulated 0th order wave, may be filtered by filter 640 at the Fourier plane, where only the first (±1) order diffraction by SLM 610 may be allowed to pass. For example, filter 640 may include a DC filter (e.g., a chrome spot) that can filter out unmodulated 0th order wave, and a low-pass filter (e.g., an aperture) that can filter out high diffraction orders. The object beam including the first order diffraction may be demagnified by a telecentric system including first lens 630 and second lens 650, where the focal length f₁ of first lens 630 may be longer than the focal length f₂ of second lens 650 such that the object beam may be demagnified. In some embodiments, plate 684 and holographic material layer 680 may be located at the focus point of second lens 650. In some embodiments, a second telecentric system including third lens 660 and fourth lens 670 may be used to, alternatively or additionally, demagnify the object beam, where plate 684 and holographic material layer 680 may be located at the focus point of fourth lens 670. The demagnified, modulated wave-front of the object beam may interfere with a reference beam 690 (e.g., a plane wave) incident from the opposite side of the object beam at holographic material layer 680 to form a reflection-type volume hologram element 682.

To record the next hologram element, data for the next hologram element may be sent to SLM 610, and plate 684 and holographic material layer 680 may be moved to the next position by motorized 2D translation stage 685. After all hologram elements are recorded, holographic material layer 680 may be processed, such as cured or bleached, to form the desired hologram that encodes the wave-front of the optical field of the target object or scene. The hologram may be reconstructed under white light illumination.

Even though not shown in FIG. 6, in some embodiments, reference beam 690 may also be modulated by a spatial-light modulator, filtered by a DC filter and/or a low-pass filter, and demagnified by one or more telecentric systems, before reaching holographic material layer 680. Using a modulated reference beam rather than a plane wave may help to, for example, record holograms that can reconstruct arbitrary and complex wave-fronts and/or reduce the requirements for the SLM used to modulate the object beam. In some embodiments, the reference beam may also be steered by a beam steering device.

In some applications, such as some three-dimensional display systems, HOEs having high spatial frequencies, large view angle ranges in the reconstructed optical fields, and high diffraction efficiencies may be used. It may be difficult to record such a large HOE using holographic printing techniques described above due to, for example, the limited resolution and spatial frequency bandwidth of the SLMs, even if the HOE is recorded in a series of exposures where one hologram element of the HOE that includes a 2D array of hologram elements is recorded in each exposure as described above.

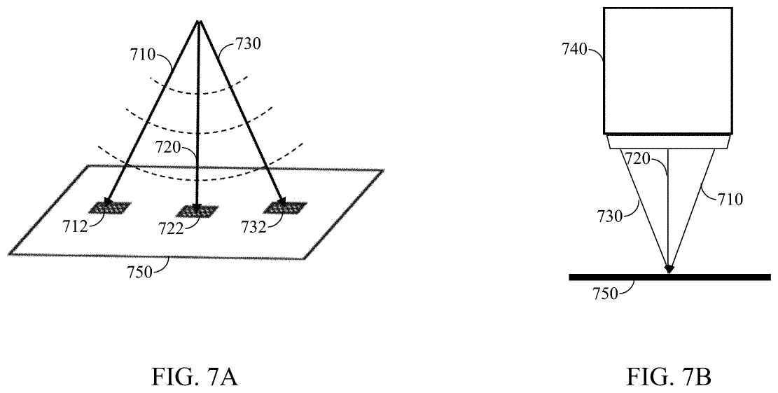

FIG. 7A illustrates examples of desired wave-fronts of object waves for recording holographic optical elements in a holographic material layer 750. In the illustrated examples, the desired HOEs 712, 722, and 732 may be holographic lenses. For example, HOE 712 may be a holographic lens with a center offset from the optical axis of the holographic lens, and may be recorded using an object wave 710. HOE 722 may be a holographic lens with a center at the optical axis of the holographic lens, and may be recorded using an object wave 720. HOE 732 may be a holographic lens with a center offset from the optical axis of the holographic lens, and may be recorded using an object wave 730. Object wave 710, object wave 720, and object wave 730 may be spherical waves, where the wave-fronts may each be a portion of a surface of a sphere.

FIG. 7B illustrates examples of object waves generated by an optical subsystem 740 of a holographic printer for recording the holographic optical elements of FIG. 7A in holographic material layer 750. Optical subsystem 740 may include an SLM that can implement a CGH or other fringe patterns. When illuminated by an collimated beam, the holographic fringe pattern implemented by the SLM may modulate the collimated beam (e.g., by diffraction) to generate an object wave with the desired wave-front for recording a holographic optical element in holographic material layer 750. For example, to record HOE 712, optical subsystem 740 may generate object wave 710; to record HOE 722, optical subsystem 740 may generate object wave 720; to record HOE 732, optical subsystem 740 may generate object wave 730. The object wave generated by optical subsystem 740 may interfere with a reference beam (e.g., a plane wave) to form the fringe pattern in holographic material layer 750.

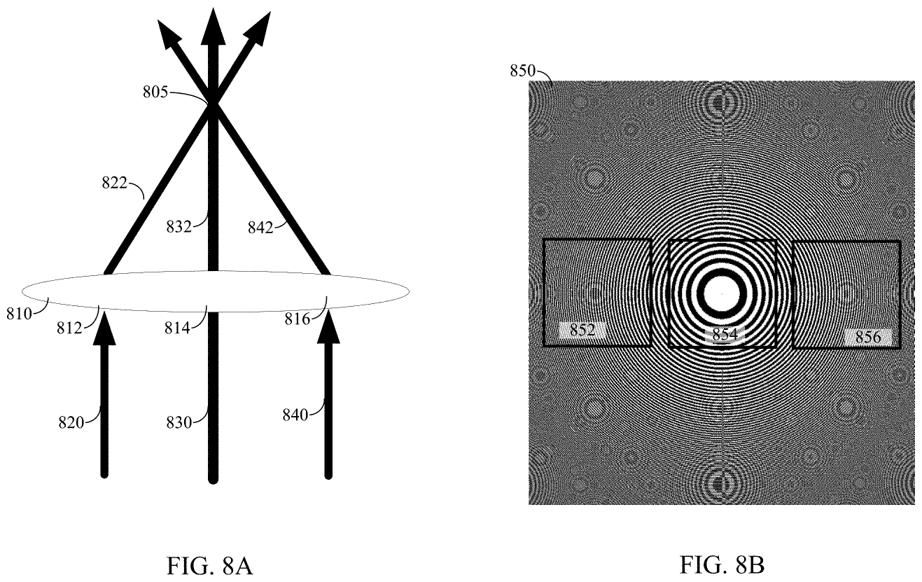

FIG. 8A illustrates an example of a method for generating desired object waves for recording holographic optical elements. To generate a spherical wave for recording a holographic lens, a collimated laser beam (a plane wave) may pass through a portion of a lens 810, where the lens may modify the wave-front of the laser beam from a plane wave to a spherical wave. Depending on the location where the collimated laser beam is incident on lens 810, lens 810 may change the propagation direction of the wave-front of the laser beam differently. For example, when a collimated light beam 820 is incident on lens 810 at a first region 812, a spherical wave with a center 805 and a propagation direction 822 may be generated. When a collimated light beam 830 is incident on lens 810 at a second region 814 (e.g., a center region), a spherical wave with a center 805 and a propagation direction 832 may be generated. When a collimated light beam 840 is incident on lens 810 at a third region 816, a spherical wave with a center 805 and a propagation direction 842 may be generated. The wave-front modification function of lens 810 or each region of lens 810 may be achieved by a CGH that can be implemented using an SLM.

FIG. 8B illustrates examples of computer-generated holograms for generating the desired object waves for recording holographic optical elements. For example, a CGH 850 may be able to perform the wave-front modification function of lens 810. A portion 852 of CGH 850 may perform the wave-front modification function of first region 812 of lens 810. A portion 854 of CGH 850 may perform the wave-front modification function of second region 814 of lens 810. A portion 856 of CGH 850 may perform the wave-front modification function of third region 816 of lens 810. As shown in FIG. 8B, the fringe patterns in portions 852 and 856 of CGH 850 may have much higher spatial frequencies than the fringe pattern in portion 854 of CGH 850.

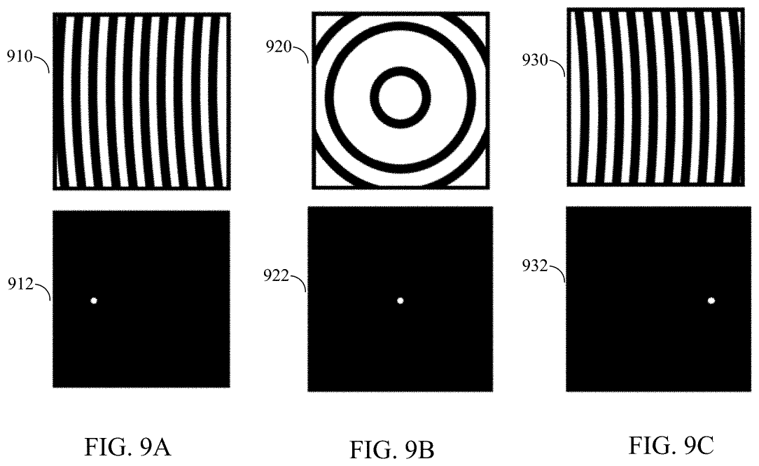

FIG. 9A illustrates an example of a fringe pattern 910 implemented using a spatial-light modulator for generating a desired object wave to record a holographic optical element, and Fourier spectra 912 of fringe pattern 910 on a Fourier plane. Fringe pattern 910 may perform the wave-front modulation function of an off-centered lens, such as first region 812 of lens 810. Fourier spectra 912 of fringe pattern 910 include components that are not in the center region of Fourier spectra 912, indicating that fringe pattern 910 may have a high spatial frequency.

FIG. 9B illustrates an example of a fringe pattern 920 implemented using a spatial-light modulator for generating a desired object wave to record a holographic optical element, and Fourier spectra 922 of fringe pattern 920 on a Fourier plane. Fringe pattern 920 may perform the wave-front modulation function of a centered lens, such as second region 814 of lens 810. Fourier spectra 922 of fringe pattern 920 include components that are in the center region of Fourier spectra 922, indicating that fringe pattern 920 may have a low spatial frequency.

FIG. 9C illustrates an example of a fringe pattern 930 implemented using a spatial-light modulator for generating a desired object wave to record a holographic optical element, and Fourier spectra 932 of fringe pattern 930 on a Fourier plane. Fringe pattern 930 may perform the wave-front modulation function of an off-centered lens, such as third region 816 of lens 810. Fourier spectra 932 of fringe pattern 930 include components that are not in the center region of Fourier spectra 932, indicating that fringe pattern 930 may have a high spatial frequency.

As shown in FIGS. 8B and 9A-9C, the spatial frequencies of some fringe patterns may be very high, and thus the fringe patterns may not be generated using an SLM that may have a limited resolution and spatial frequency even if the SLM has a sufficient large number of pixels.

According to certain embodiments, a beam steering device may be used in combination with a spatial-light modulator in a holographic printing system to record large HOEs that can diffract light with large diffraction angles at high diffraction efficiencies. The SLM may generate an object beam with fundamental spatial frequencies. The beam steering device may then steer the object beam generated by the SLM to a desired direction, which shifts the fundamental spatial frequencies of the object beam to high spatial frequencies. Thus, the SLM and the beam steering device, in combination, may generate an object beam with high spatial frequencies.

In some embodiments, the beam steering device may include an active grating with a variable pitch. The active grating with the variable pitch may have a variable spatial frequency, and thus may shift the fundamental spatial frequencies of the object beam generated by the SLM to higher spatial frequencies. In some embodiments, the beam steering device may include a scanning mirror, such as a Galvo mirror or a micro-electro-mechanical system (MEMS) mirror.

According to certain embodiments, the beam steering device may include a switchable grating stack that includes multiple gratings having the same or different pitches. The switchable grating stack can be switched to direct an object beam generated by the SLM to desired directions, which shifts the fundamental spatial frequencies of the object beam to high spatial frequencies. Thus, object beams with desired high spatial frequencies may be generated by a combination of the SLM and the beam steering device. In this way, large HOEs with large diffraction angles can be recorded using an SLM having a lower resolution or a lower maximum achievable spatial frequency. In some embodiments, the gratings in the switchable grating stack may be switchable. In some embodiments, the switchable grating stack may include switchable polarization converters (e.g., switchable half-wave plates). In some embodiments, the switchable grating stack may include at least one of a switchable grating or a switchable polarization converter.

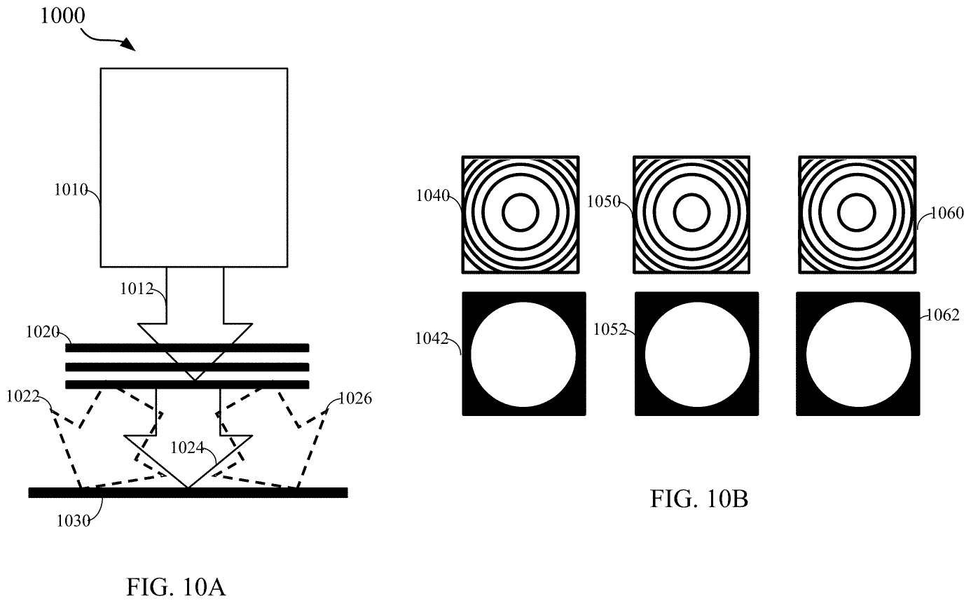

FIG. 10A illustrates an example of a holographic wave-front recording system 1000 including a spatial-light modulator 1010 and a switchable grating stack 1020 according to certain embodiments. As described above, SLM 1010 may include a 2D array of pixels controlled by a control circuit. The control circuit may receive data for a fringe pattern (e.g., a CGH) and apply different voltage signals on the pixels of SLM 1010 based on the received data, such that SLM 1010 may implement the fringe pattern. When illuminated by a collimated beam, pixels of SLM 1010 that implements the fringe pattern may modulate the phase and/or amplitude of the collimated beam by diffraction to generate an object beam 1012. Due to the limited resolution and spatial frequency of the fringe pattern that can be implemented by SLM 1010, object beam 1012 may have relatively small diffraction angles, and thus may be viewable from a small angular range.

The switchable grating stack 1020 may include multiple gratings that can be configured to diffract or not diffract incident light, or to diffract incident light of different polarization states by different diffraction angles. In some embodiments, the gratings in switchable grating stack 1020 may include switchable gratings that can be in the “ON” state to diffract incident light when no voltage signal is applied on a switchable grating, and can be switched to the “OFF” state to not diffract (e.g., transmit) the incident light when a voltage signal higher than a threshold voltage is applied on the switchable grating. In some embodiments, one or more gratings in switchable grating stack 1020 may be polarization dependent and may diffract incident light of different polarization states to different directions. In some embodiments, switchable grating stack 1020 may include one or more switchable polarization converters, such as switchable half-wave plates and/or switchable polarizers that may be configured to change the polarization state of the incident light or to maintain the polarization state of the incident light.

The multiple gratings in switchable grating stack 1020 may have different grating periods or the same grating period. In one example, each of the multiple gratings may have a different respective grating period, and thus may diffract an incident beam by different diffraction angles. Thus, when the multiple gratings in switchable grating stack 1020 are configured differently (e.g., switched on or off, or receiving light of different polarization states), switchable grating stack 1020 may diffract incident object beam 1012 to different directions as illustrated by object beams 1022, 1024, and 1026 that propagate in different directions. As such, switchable grating stack 1020 may be a beam steering device that can direct the incident light to a set of directions. In addition, the distances between the gratings in switchable grating stack 1020 and between a holographic material layer 1030 and switchable grating stack 1020 may be configured such that the incident light may be directed to a set of desired regions on holographic material layer 1030. Therefore, switchable grating stack 1020 may be controlled such that an incident light beam may be steered by switchable grating stack 1020 to reach a desired region on holographic material layer 1030 from a desired direction.

FIG. 10B illustrates examples of fringe patterns implemented using a spatial-light modulator (e.g., SLM 1010) for generating desired object waves to record holographic optical elements, and the Fourier spectra of the fringe patterns on a Fourier plane according to certain embodiments. For example, to generate object beam 1022, the SLM may be controlled to implement a fringe pattern 1040 that may perform the wave-front modulation function of a centered lens, such as second region 814 of lens 810. Fourier spectra 1042 of fringe pattern 1040 include components that are in the center region of Fourier spectra 1042, indicating that fringe pattern 1040 may have low spatial frequencies. The object beam (e.g., object beam 1012) generated by the diffraction of a collimated laser beam by fringe pattern 1040 may then be steered by switchable grating stack 1020 that is configured to direct object beam 1012 to the direction of object beam 1022 shown in FIG. 10A.

To generate object beam 1024, the SLM may be controlled to implement a fringe pattern 1050 that may perform the wave-front modulation function of a centered lens, such as second region 814 of lens 810. Thus, fringe pattern 1050 may be the same as or similar to fringe pattern 1040. Fourier spectra 1052 of fringe pattern 1050 include components that are in the center region of Fourier spectra 1052, indicating that fringe pattern 1050 may have low spatial frequencies. The object beam (e.g., object beam 1012) generated by the diffraction of a collimated laser beam by fringe pattern 1050 may then be steered by the switchable grating stack 1020 to the direction of object beam 1024 shown in FIG. 10A. For example, the gratings in switchable grating stack 1020 may be switched off by applying voltage signals on the gratings, or the polarization state of the light incident on each grating may be set (e.g., by a switchable polarization converter) such that object beam 1012 may not change the propagation direction after passing through switchable grating stack 1020.

To generate object beam 1026, the SLM may be controlled to implement a fringe pattern 1060 that may perform the wave-front modulation function of a centered lens, such as second region 814 of lens 810. Thus, fringe pattern 1060 may be the same as or similar to fringe pattern 1040 and fringe pattern 1050. Fourier spectra 1062 of fringe pattern 1060 include components that are in the center region of Fourier spectra 1062, indicating that fringe pattern 1060 may have low spatial frequencies. The object beam (e.g., object beam 1012) generated by the diffraction of a collimated laser beam by fringe pattern 1060 may then be steered by the switchable grating stack 1020 that are configured to direct object beam 1012 to the direction of object beam 1026 as described above with respect to FIG. 10A.

As such, compared with the SLM in the holographic printing systems described above with respect to FIGS. 7A-9C, SLM 1010 used in holographic wave-front recording system 1000 may not need to have a high resolution and a high achievable spatial frequency in order to record HOEs 712, 722, and 732.

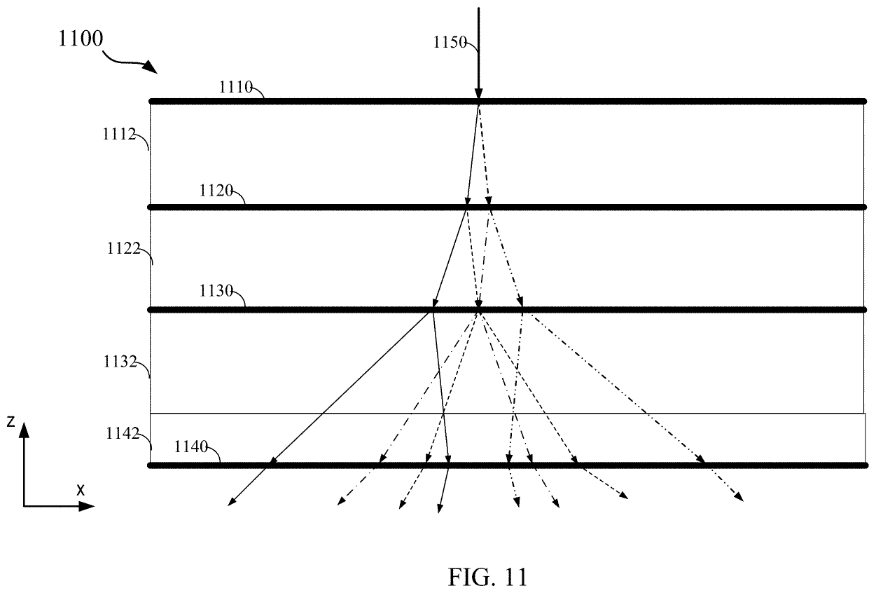

FIG. 11 illustrates an example of a beam steering device 1100 including a switchable grating stack for steering an object beam to a large angular range according to certain embodiments. Beam steering device 1100 may be an example of switchable grating stack 1020. In the illustrated example, the switchable grating stack may include a first polarization grating 1110, a second polarization grating 1120, and a third polarization grating 1130. First polarization grating 1110, second polarization grating 1120, and third polarization grating 1130 may diffract incident light of different polarization states differently. For example, in some embodiments, a polarization grating may diffract left-handed circularly polarized light and transmit right-handed circularly polarized light, or may diffract right-handed circularly polarized light and transmit left-handed circularly polarized light. In some embodiments, a polarization grating may diffract left-handed circularly polarized light to a first direction and diffract right-handed circularly polarized light to a second direction, or may diffract right-handed circularly polarized light to the first direction and diffract left-handed circularly polarized light to the second direction.

First polarization grating 1110, second polarization grating 1120, and third polarization grating 1130 may be separated by spacers 1112 and 1122, such as thin substrates or thin films. In some embodiments, the switchable grating stack shown in FIG. 11 may include one or more passive or active polarizers or other polarization converters before one or more gratings in the stack. For example, spacers 1112 and 1122 may include one or more polarizers. The one or more polarization converters may change the polarization state of the light beam, such as converting the polarization state of the light beam from left-handed circular polarization (LHCP) to right-handed circular polarization (RHCP), or vice versa. In some embodiments, the one or more polarization converters may be active polarization converters that can be switched on or off. For example, the one or more polarization converters may include switchable half-wave plates that can be switched on to change the polarization state of the incident light to the opposite polarization state (e.g., from LHCP to RHCP, or from RHCP to LHCP), and can be switched off to maintain the polarization state of the incident light.

In some embodiments, at least one of first polarization grating 1110, second polarization grating 1120, or third polarization grating 1130 may be an active grating that can be switched on to diffract incident light and can be switched off to transmit incident light. For example, a polarization grating may be in the “ON” state to diffract incident light when no voltage signal is applied on the polarization grating, and may be switched to the “OFF” state to not diffract (e.g., transmit) the incident light when a voltage signal higher than a threshold level is applied on the polarization grating.

The polarization gratings may have different respective grating periods, and thus may diffract an incident beam by different diffraction angles. For example, first polarization grating 1110 may diffract different circularly polarized incident beams by about ±5.3° in the first diffraction orders, second polarization grating 1120 may diffract different circularly polarized incident beams by about ±10.8° in the first diffraction orders, and third polarization grating 1130 may diffract different circularly polarized incident beams by about ±22° in the first diffraction orders. Thus, when the polarization gratings and/or the polarization converters in the stack are configured differently (e.g., switched on or off), the switchable grating stack may diffract an incident object beam 1150 to different directions as shown in FIG. 11.

In addition, first polarization grating 1110, second polarization grating 1120, and third polarization grating 1130 may be separated from each other by certain distances by spacers. In the example shown in FIG. 11, spacer 1112 may have a thickness about 0.3 mm, and spacer 1122 may also have a thickness about 0.3 mm. Third polarization grating 1130 may be separated from the holographic material layer 1140 that is on a substrate 1142 by a spacer 1132. In the example shown in FIG. 11, spacer 1132 may have a thickness about 0.4 mm. First polarization grating 1110, second polarization grating 1120, third polarization grating 1130, and holographic material layer 1140 may be arranged such that incident object beam 1150 may be directed to at least eight different regions on holographic material layer 1140 from different respective directions as shown in FIG. 11.

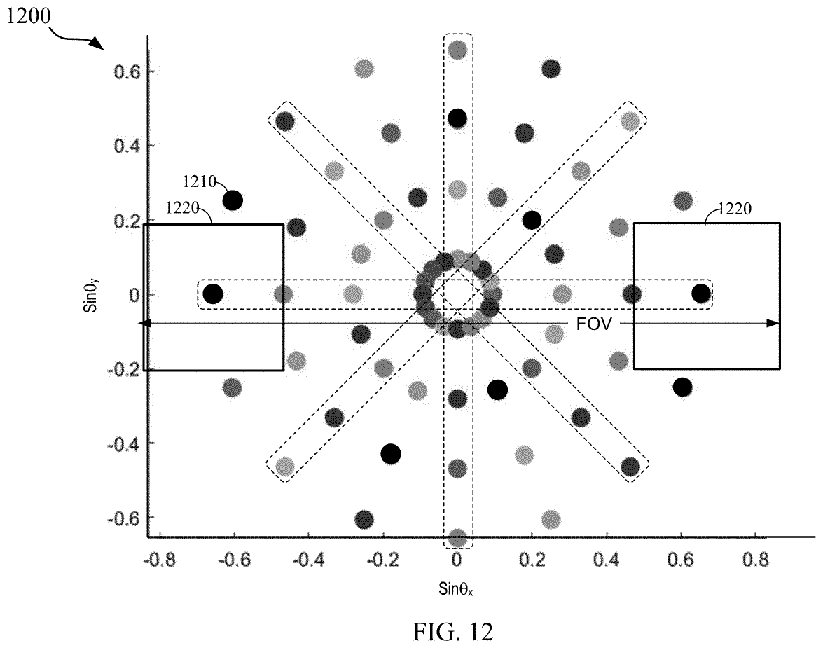

FIG. 12 includes a diagram 1200 illustrating examples of object beam steering by the switchable grating stack shown in FIG. 11 according to certain embodiments. Each circle 1210 represents the center of an object beam steered by the switchable grating stack. A box 1220 centered around a circle 1210 in FIG. 12 indicates the spatial frequency range of the fringe pattern implemented by an SLM for generating the base object beam as shifted by the switchable grating stack. The switchable grating stack may steer the center of the object beam to one of eight locations in each direction in the X-Y plane, such that the object beam may cover a field of view of about ±60° in each direction in the X-Y plane.

The switchable grating stack described above may be implemented using, for example, polarization volume gratings (PVGs), switchable Bragg gratings (SBGs), Pancharatnam-Berry phase (PBP) gratings, optical phased arrays (OPAs), liquid crystal gratings, SLMs, passive or active linear polarizers, passive or active circular polarizers, passive or active waveplates, or any combinations thereof.

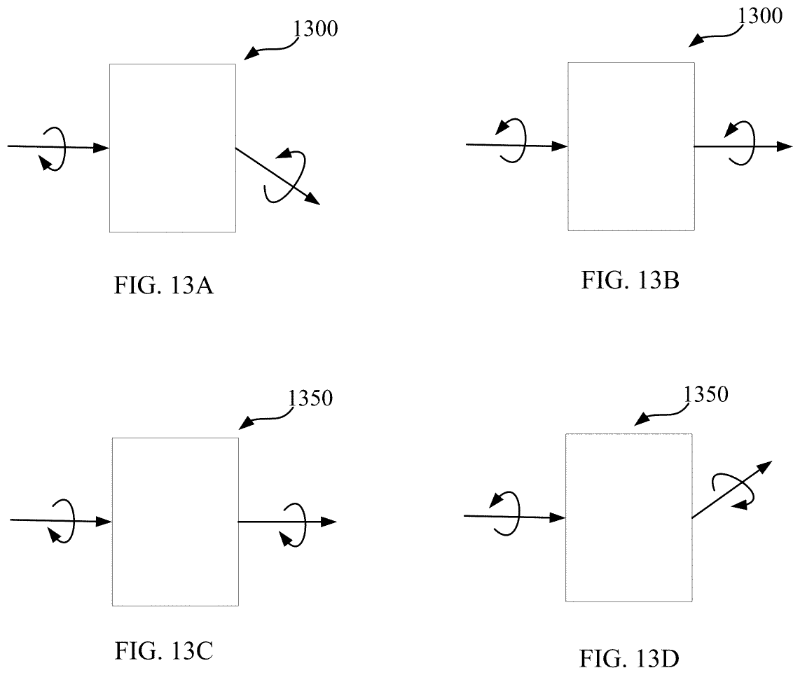

FIGS. 13A-13D illustrate operations of examples of polarization volume gratings according to certain embodiments. PVGs may include, for example, liquid crystal molecules with photo-alignment materials, or other patterned birefringent nanostructures. PVGs can operate in a reflective mode or a transmissive mode, and may be polarization-selective. In one example, a PVG may include liquid crystal molecules arranged in a helical structure. Such a PVG may be referred to as a left-handed (LH) PVG when the liquid crystal molecules are arranged in a counter-clockwise rotational pattern when viewed in the light propagation direction, or a right-handed (RH) PVG when the liquid crystal molecules are arranged in a clockwise rotational pattern when viewed in the light propagation direction. For a given light propagation direction, an LH PVG may be flipped to serve as an RH PVG, and an RH PVG may be flipped to serve as an LH PVG. Thus, the designation of the LH PVG and the RH PVG describes the interaction between the PVG and the input light, rather than different types of PVGs. PVGs, such as liquid crystal (LC) PVGs, may be switched off when an electrical field is applied to the PVGs to realign the liquid crystal molecules along the direction of the electrical field.

FIG. 13A illustrates the operation of an RH PVG 1300 on incident light having the right-handed circular polarization. RH PVG 1300 may diffract the incident light having the right-handed circular polarization to a particular angle, such as the direction of the −1 diffraction order. RH PVG 1300 may also change the polarization of the incident light having the right-handed circular polarization to light having the left-handed circular polarization.

FIG. 13B illustrates the operation of RH PVG 1300 on incident light having the left-handed circular polarization. As illustrated, RH PVG 1300 may transmit most or all the incident light having the left-handed circular polarization without diffraction. RH PVG 1300 may also maintain the polarization state of the incident light having the left-handed circular polarization.

FIG. 13C illustrates the operation of an LH PVG 1350 on incident light having the right-handed circular polarization. As illustrated, LH PVG 1350 may transmit most or all the incident light having the right-handed circular polarization without diffraction. LH PVG 1350 may also maintain the polarization state of the incident light having the right-handed circular polarization.

FIG. 13D illustrates the operation of LH PVG 1300 on incident light having the left-handed circular polarization. LH PVG 1350 may diffract the incident light having the left-handed circular polarization to a particular angle, such as the direction of the +1 diffraction order. LH PVG 1350 may also change the polarization of the incident light having the left-handed circular polarization to light having the right-handed circular polarization.

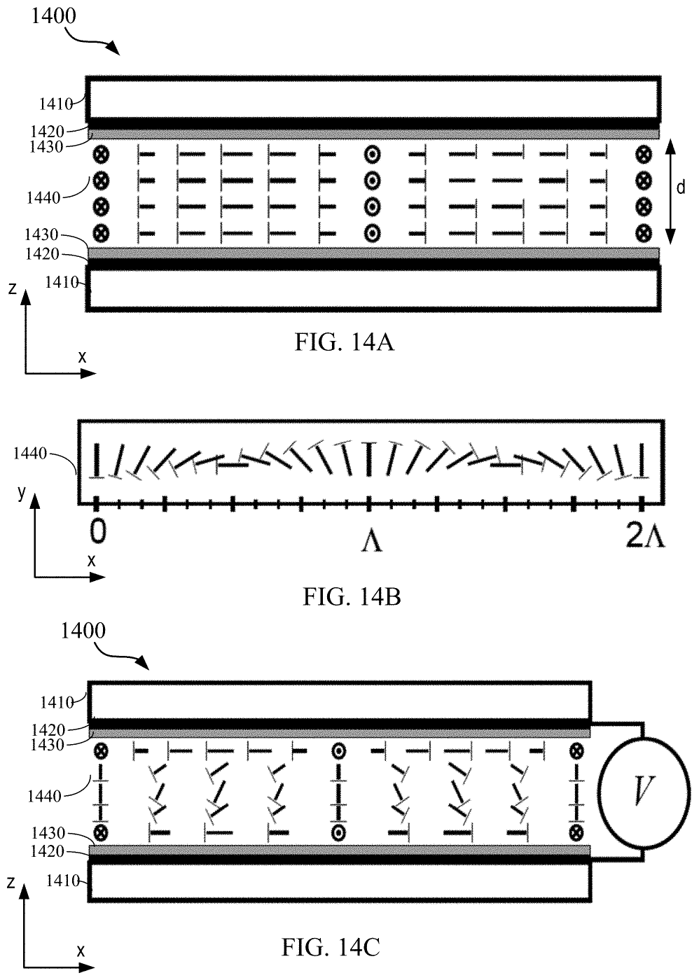

FIG. 14A is a top view of an example of a switchable PBP grating 1400 according to certain embodiments. PBP grating 1400 may be an example of the gratings in switchable grating stack 1020, first polarization grating 1110, second polarization grating 1120, or third polarization grating 1130. PBP grating 1400 may include a pair of substrates 1410, a pair of electrodes 1420, one or two surface alignment layers 1430, and a liquid crystal layer 1440. Substrate 1410 may be transparent to visible light. Electrodes 1420 may also be transparent to visible light and may be implemented using, for example, indium tin oxide (ITO). Surface alignment layers 1430 may have a predefined surface pattern, such that liquid crystal molecules in liquid crystal layer 1440 may self-align in the same pattern when no voltage is applied to PBP grating 1400.

FIG. 14B is a side view of the example of switchable PBP grating 1400 according to certain embodiments. As illustrated, liquid crystal layer 1440 in PBP grating 1400 may include liquid crystal molecules that are oriented in a repetitive rotational pattern in the x-y plane when viewed in the light propagation direction (e.g., z direction). The repetitive rotational pattern may be created by, for example, recording the interference of two orthogonally circular-polarized laser beams in a polarization-sensitive photo-alignment material. Due to the repetitive rotational pattern of the liquid crystal structure in the x-y plane, PBP grating 1400 may have an in-plane, uniaxial birefringence that varies with position. The liquid crystal structure having the repetitive rotational pattern may give rise to a geometric-phase shift of incident light due to the polarization evolution as the light propagates through the liquid crystal structure.

The diffraction efficiency of PBP grating 1400 at normal incidence may be approximately determined by:

$${η}_{0} = {cos}^{2} ( \frac{πΔ nd}{λ} ) , and$$

$${η}_{\pm 1} = \frac{1 \overline{+} {S}_{3}^{′}}{2} {sin}^{2} ( \frac{πΔ nd}{λ} ) ,$$

where ηₘ is the diffraction efficiency of the m diffraction order, Δn is the birefringence of liquid crystal layer 1440, d is the thickness of liquid crystal layer 1440, λ is the wavelength of incident light, and S′₃=S₃/S₀ is the normalized Stokes parameter corresponding to the ellipticity of the polarization of the incident light. Thus, if thickness d=λ/2Δn (half-wave retardation of LC layer 1440), the zeroth order transmission η₀ may be zero, and all incident light may be diffracted to the ±1 orders. The ±1 diffraction orders may be sensitive to S′₃, while the zeroth-order may be polarization independent. For example, when the incident light has a right-handed circular polarization, S′₃=−1, and thus η₊₁=1 and η₋₁=0, which indicates that all incident light passing through PBP grating 1400 may be diffracted into the +1 order. When the incident light has a left-handed circular polarization, S′₃=+1, η₊₁=0, and η₋₁=1, which indicates that all incident light is diffracted into the negative first order. Although m=+1 is herein considered the primary order and the m=−1 order is considered the conjugate order, the designation of the orders may be reversed or otherwise changed. In general, only the zeroth and the two first diffracted orders may be possible, regardless of the grating period A and the thickness d.

Moreover, after passing through PBP grating 1400, the handedness of the circularly polarized light may be changed to the opposite circular polarization state as the light may experience a relative phase shift in LC layer 1440. For example, after the right-handed circularly polarized light passes through PBP grating 1400, the polarization state of the light may be changed to the left-handed circular polarization. After the left-handed circularly polarized light passes through PBP grating 1400, the polarization state of the light may be changed to the right-handed circular polarization.

The pitch or period A of the repetitive rotational pattern of the liquid crystal molecules in PBP grating 1400 may determine, in part, certain optical properties of the PBP grating. For example, the pitch may determine the diffraction angles of the different diffraction orders according to the grating equation. Generally, the smaller the pitch, the larger the diffraction angles for a given wavelength of light and a given diffraction order.

FIG. 14C is a top view of the example of switchable PBP grating 1400 that is switched off according to certain embodiments. PBP grating 1400 may be switched off by applying a voltage signal to electrodes 1420. When the level of the voltage signal is greater than a threshold level, the electric field within liquid crystal layer 1440 may align the liquid crystal molecules, and the effective birefringence Δn may be reduced to about zero. Thus, the voltage signal may effectively erase or switch off PBP grating 1400, such that incident light may pass through PBP grating 1400 without changing the propagation direction and the polarization state.

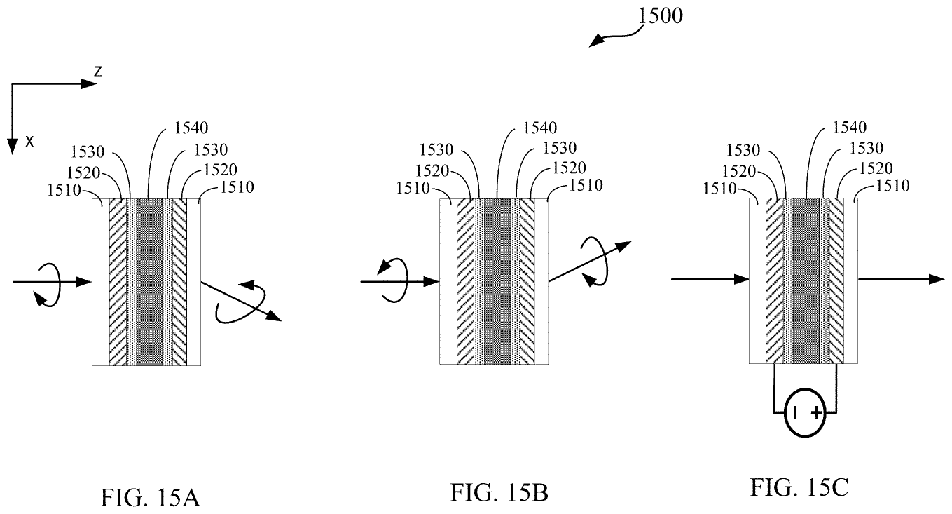

FIGS. 15A-15C illustrate operations of an example of a switchable PBP grating 1500 according to certain embodiments. PBP grating 1500 may be an example of PBP grating 1400. In the illustrated example, PBP grating 1500 may include a pair of substrates 1510, a pair of electrodes 1520, one or two surface alignment layers 1530, and a liquid crystal layer 1540. Substrate 1510 may be transparent to visible light. Electrodes 1520 may also be transparent to visible light and may be implemented using, for example, indium tin oxide (ITO). Surface alignment layers 1530 may have a predefined surface pattern, such that liquid crystal molecules in liquid crystal layer 1540 may self-align in the same pattern when no voltage is applied to PBP grating 1500. In the illustrated example, PBP grating 1500 may be used as a right-handed grating, where the liquid crystal molecules in liquid crystal layer 1540 may be arranged in a clockwise rotational pattern in the x-y plane when viewed in the light propagation direction (e.g., z-direction).

FIG. 15A illustrates an example of the diffraction of a right-handed circularly polarized incident light beam by PBP grating 1500 in an “ON” state. When no voltage signal (or a voltage signal below a threshold voltage) is applied to electrodes 1520 of PBP grating 1500, PBP grating 1500 may be in the “ON” state because the built-in grating is not erased or switched off. PBP grating 1500 may diffract incident light with a right-handed circular polarization to a first direction (e.g., the direction of the −1 diffraction order), where the light output from PBP grating 1500 may become left-handed circularly polarized after passing through PBP grating 1500.

FIG. 15B illustrates an example of the diffraction of a left-handed circularly polarized incident light beam by PBP grating 1500 in the “ON” state. When no voltage signal (or a voltage signal below a threshold voltage) is applied to electrodes 1520 of PBP grating 1500, PBP grating 1500 may be in the “ON” state as the built-in grating is not erased or switched off. PBP grating 1500 may diffract incident light with the left-handed circular polarization to a second direction (e.g., the direction of the +1 diffraction order), where the light output from PBP grating 1500 may become right-handed circularly polarized after passing through PBP grating 1500.

FIG. 15C illustrates an example of the transmission of an incident light beam by PBP grating 1500 in the “OFF” state. When a voltage signal higher than the threshold voltage is applied to electrodes 1520 of PBP grating 1500, PBP grating 1500 may be in the “OFF” state as the built-in grating may be erased or switched off as described above with respect to FIG. 14C. In the “OFF” state, PBP grating 1500 may not diffract the incident light beam, regardless of the polarization state of the incident light beam, where the light beam output (e.g., transmitted) from PBP grating 1500 may have the same polarization state as the incident light beam.

If PBP grating 1500 is flipped with respect to the incident light beam, PBP grating 1500 may become left-handed, where the liquid crystal molecules in liquid crystal layer 1540 may be arranged in a counter-clockwise rotational pattern in the x-y plane when viewed in the light propagation direction (e.g., z-direction). The flipped PBP grating may have different diffraction properties in the “ON” state.

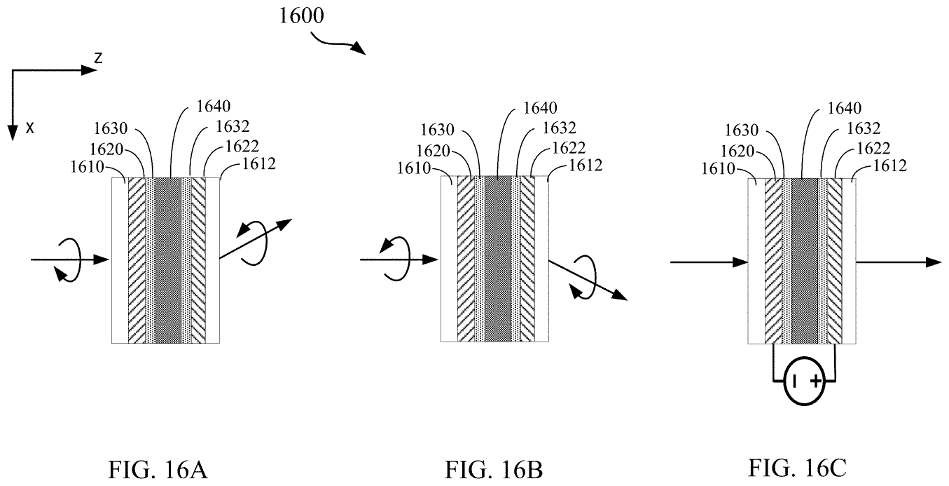

FIGS. 16A-16C illustrate operations of an example of a switchable PBP grating 1600 according to certain embodiments. PBP grating 1600 may be an example of PBP grating 1400, and may be similar to PBP grating 1500 with light incident from an opposite direction. In the illustrated example, PBP grating 1600 may include a pair of substrates 1610, a pair of electrodes 1620, one or two surface alignment layers 1630, and a liquid crystal layer 1640. Substrate 1610 may be transparent to visible light. Electrodes 1620 may also be transparent to visible light and may be implemented using, for example, indium tin oxide (ITO). Surface alignment layers 1630 may have a predefined surface pattern, such that liquid crystal molecules in liquid crystal layer 1640 may self-align in the same pattern when no voltage is applied to PBP grating 1600. In the illustrate example, PBP grating 1600 may be a left-handed grating, where the liquid crystal molecules in liquid crystal layer 1640 may be arranged in a counter-clockwise rotational pattern in the x-y plane when viewed in the light propagation direction (e.g., z-direction).

FIG. 16A illustrates an example of the diffraction of a right-handed circularly polarized incident light beam by PBP grating 1600 in an “ON” state. When no voltage signal (or a voltage signal below a threshold voltage) is applied to electrodes 1620 of PBP grating 1600, PBP grating 1600 may be in the “ON” state because the built-in grating is not erased or switched off. PBP grating 1600 may diffract incident light with the right-handed circular polarization to a first direction (e.g., the direction of the +1 diffraction order), where the light output from PBP grating 1600 may become left-handed circularly polarized after passing through PBP grating 1600.

FIG. 16B illustrates an example of the diffraction of a left-handed circularly polarized incident light beam by PBP grating 1600 in the “ON” state. When no voltage signal (or a voltage signal below a threshold voltage) is applied to electrodes 1620 of PBP grating 1600, PBP grating 1600 may be in the “ON” state as the built-in grating is not erased or switched off. PBP grating 1600 may diffract incident light with the left-handed circular polarization to a second direction (e.g., the direction of the −1 diffraction order), where the light output from PBP grating 1600 may become right-handed circularly polarized after passing through PBP grating 1600.

FIG. 16C illustrates an example of the transmission of an incident light beam by PBP grating 1600 in the “OFF” state. When a voltage signal higher than the threshold voltage is applied to electrodes 1620 of PBP grating 1600, PBP grating 1600 may be in the “OFF” state as the built-in grating may be erased or switched off as described above with respect to FIG. 14C. In the “OFF” state, PBP grating 1600 may not diffract the incident light beam, regardless of the polarization state of the incident light beam, where the light beam output (e.g., transmitted) from PBP grating 1600 may have the same polarization state as the incident light beam.

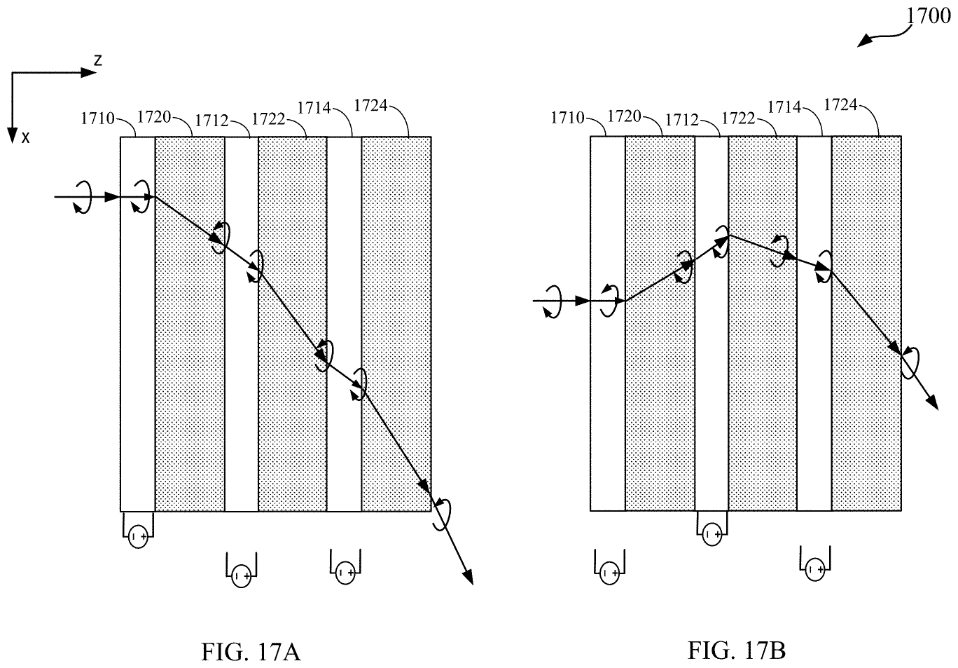

FIG. 17A illustrates an example of an operation of a beam steering device 1700 according to certain embodiments. In the illustrated example, beam steering device 1700 may include a first switchable polarization converter 1710, a first polarization grating 1720, a second switchable polarization converter 1712, a second polarization grating 1722, a third switchable polarization converter 1714, and a third polarization grating 1724 arranged in a stack. As described above, switchable polarization converters 1710, 1712, and 1714 may convert an incoming circularly polarized light beam into a light beam having the opposite circular polarization state (e.g., from LHCP to RHCP, or from RHCP to LHCP). For example, each of switchable polarization converters 1710, 1712, and 1714 may include a switchable half-wave plate that can be switched on (e.g., with no voltage signal applied) to change the polarization state of the incident light to the opposite polarization state, and can be switched off (e.g., with a voltage signal applied) to maintain the polarization state of the incident light.

First polarization grating 1720, second polarization grating 1722, and third polarization grating 1724 may be passive polarization-dependent gratings or active polarization-dependent gratings described above, such as the PVGs or the passive or active PBP gratings described above. Each of first polarization grating 1720, second polarization grating 1722, and third polarization grating 1724 may be a right-handed polarization grating or a left-handed polarization grating. First polarization grating 1720, second polarization grating 1722, and third polarization grating 1724 may have different grating periods and thus may have different diffraction angles for the same diffraction order. For example, first polarization grating 1720 may have a first grating period such that it may diffract surface-normal incident light to the +1 diffraction order with a diffraction angle θ; second polarization grating 1722 may have a second grating period such that it may diffract surface-normal incident light to the +1 diffraction order with a diffraction angle 20; and third polarization grating 1724 may have a third grating period such that it may diffract surface-normal incident light to the +1 diffraction order with a diffraction angle 40.

In the example shown in FIG. 17A, first polarization grating 1720, second polarization grating 1722, and third polarization grating 1724 may be passive right-handed circular polarization gratings or may be active right-handed circular polarization gratings that remain in the “ON” state to diffract incident light. First switchable polarization converter 1710 may be switched off by an applied voltage signal, and thus may transmit a right-handed circularly polarized light beam without changing it polarization state. First polarization grating 1720 may diffract the right-handed circularly polarized light beam in the −1 diffraction order and change the output light beam to a left-handed circularly polarized light beam. Second switchable polarization converter 1712 may be switched on by disconnecting it from a voltage signal, and thus may convert the left-handed circularly polarized light beam into a right-handed circularly polarized light beam. Second polarization grating 1722 may diffract the right-handed circularly polarized light beam in the −1 diffraction order and change the output light beam to a left-handed circularly polarized light beam. Third switchable polarization converter 1714 may be switched on by disconnecting it from a voltage signal, and thus may convert the left-handed circularly polarized light beam into a right-handed circularly polarized light beam. Third polarization grating 1724 may diffract the right-handed circularly polarized light beam in the −1 diffraction order and change the output light beam to a left-handed circularly polarized light beam.

FIG. 17B illustrates another example of an operation of beam steering device 1700 according to certain embodiments. In the example shown in FIG. 17B, first switchable polarization converter 1710 may be switched on by disconnecting it from a voltage signal, and thus may convert a right-handed circularly polarized incident light beam to a left-handed circularly polarized light beam. First polarization grating 1720 may diffract the left-handed circularly polarized light beam in the +1 diffraction order and change the output light beam to a right-handed circularly polarized light beam. Second switchable polarization converter 1712 may be switched off by an applied voltage signal, and thus may transmit the right-handed circularly polarized light beam without changing its polarization state. Second polarization grating 1722 may diffract the right-handed circularly polarized light beam in the −1 diffraction order and change the output light beam to a left-handed circularly polarized light beam. Third switchable polarization converter 1714 may be switched on by disconnecting it from a voltage signal, and thus may convert the left-handed circularly polarized light beam into a right-handed circularly polarized light beam. Third polarization grating 1724 may diffract the right-handed circularly polarized light beam in the −1 diffraction order and change the output light beam to a left-handed circularly polarized light beam.

Therefore, by selectively switching on or off switchable polarization converters 1710, 1712, and 1714 to set the polarization states of the incident light beams for first polarization grating 1720, second polarization grating 1722, and third polarization grating 1724, an incident light beam may be directed to a direction of a set of discrete directions. For example, when first polarization grating 1720, second polarization grating 1722, and third polarization grating 1724 have different respective grating periods, beam steering device 1700 may be able to direct the incident light beam to one of eight (23) different directions.

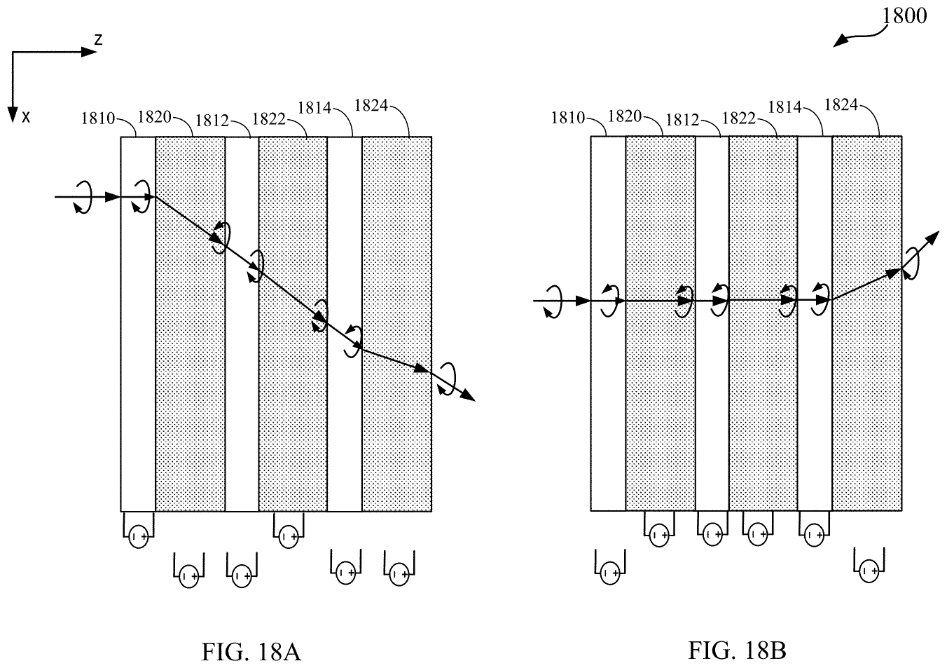

FIG. 18A illustrates an example of an operation of a beam steering device 1800 according to certain embodiments. In the illustrated example, beam steering device 1800 may include a first switchable polarization converter 1810, a first polarization grating 1820, a second switchable polarization converter 1812, a second polarization grating 1822, a third switchable polarization converter 1814, and a third polarization grating 1824 arranged in a stack. As described above, switchable polarization converters 1810, 1812, and 1814 may convert an incoming circularly polarized light beam into a light beam having the opposite circular polarization state (e.g., from LHCP to RHCP, or from RHCP to LHCP). For example, each of switchable polarization converters 1810, 1812, and 1814 may include a switchable half-wave plate that can be switched on (e.g., with no voltage signal applied) to change the polarization state of the incident light to the opposite polarization state, and can be switched off (e.g., with a voltage signal applied) to maintain the polarization state of the incident light.

First polarization grating 1820, second polarization grating 1822, and third polarization grating 1824 may be active polarization-dependent gratings, such as the active PBP gratings described above. Each of first polarization grating 1820, second polarization grating 1822, and third polarization grating 1824 may be a right-handed polarization grating or a left-handed polarization grating. First polarization grating 1820, second polarization grating 1822, and third polarization grating 1824 may have different grating periods and thus may have different diffraction angles for the same diffraction order. For example, first polarization grating 1820 may have a first grating period such that it may diffract surface-normal incident light to the +1 diffraction order with a diffraction angle 40; second polarization grating 1822 may have a second grating period such that it may diffract surface-normal incident light to the +1 diffraction order with a diffraction angle 20; and third polarization grating 1824 may have a third grating period such that it may diffract surface-normal incident light to the +1 diffraction order with a diffraction angle θ.

In the example shown in FIG. 18A, first switchable polarization converter 1810 may be switched off by an applied voltage signal, and thus may transmit a right-handed circularly polarized light beam without changing it polarization state. First polarization grating 1820 may be switched on by disconnecting it from a voltage signal and thus may diffract the right-handed circularly polarized light beam in the −1 diffraction order and change the output light beam to a left-handed circularly polarized light beam. Second switchable polarization converter 1812 may be switched on by disconnecting it from a voltage signal, and thus may convert the left-handed circularly polarized light beam into a right-handed circularly polarized light beam. Second polarization grating 1822 may be switched off by an applied voltage signal and thus may transmit the right-handed circularly polarized light beam (in the 0^{th} diffraction order) without changing its polarization state and propagation direction. Third switchable polarization converter 1814 may be switched on by disconnecting it from a voltage signal, and thus may convert the right-handed circularly polarized light beam into a left-handed circularly polarized light beam. Third polarization grating 1824 may be switched on by disconnecting it from a voltage signal and thus may diffract the left-handed circularly polarized light beam in the +1 diffraction order and change the output light beam to a right-handed circularly polarized light beam.

FIG. 18B illustrates an example of an operation of beam steering device 1800 according to certain embodiments. In the example shown in FIG. 18B, first switchable polarization converter 1810 may be switched on by disconnecting it from a voltage signal, and thus may convert a right-handed circularly polarized light beam into a left-handed circularly polarized light beam. First polarization grating 1820 may be switched off by an applied voltage signal and thus may transmit the left-handed circularly polarized light beam without changing its polarization state and propagation direction. Second switchable polarization converter 1812 may be switched off by an applied voltage signal, and thus may transmit the left-handed circularly polarized light beam without changing its polarization state. Second polarization grating 1822 may be switched off by an applied voltage signal and thus may transmit the left-handed circularly polarized light beam without changing its polarization state and propagation direction. Third switchable polarization converter 1814 may be switched off by an applied voltage signal, and thus may transmit the left-handed circularly polarized light beam without changing its polarization state. Third polarization grating 1824 may be switched on by disconnecting it from a voltage signal, and thus may diffract the left-handed circularly polarized light beam in the +1 diffraction order and change the output light beam to a right-handed circularly polarized light beam.

Therefore, by selectively switching on or off switchable polarization converters 1810, 1812, and 1814 to set the polarization states of the incident light beams for first polarization grating 1820, second polarization grating 1822, and third polarization grating 1824, and/or by selectively switching on or off first polarization grating 1820, second polarization grating 1822, and third polarization grating 1824, an incident light beam may be directed to any direction in a set of discrete directions. For example, when first polarization grating 1820, second polarization grating 1822, and third polarization grating 1824 have different respective grating periods, beam steering device 1800 may be able to direct the incident light beam to one of 27 (3³) different directions.

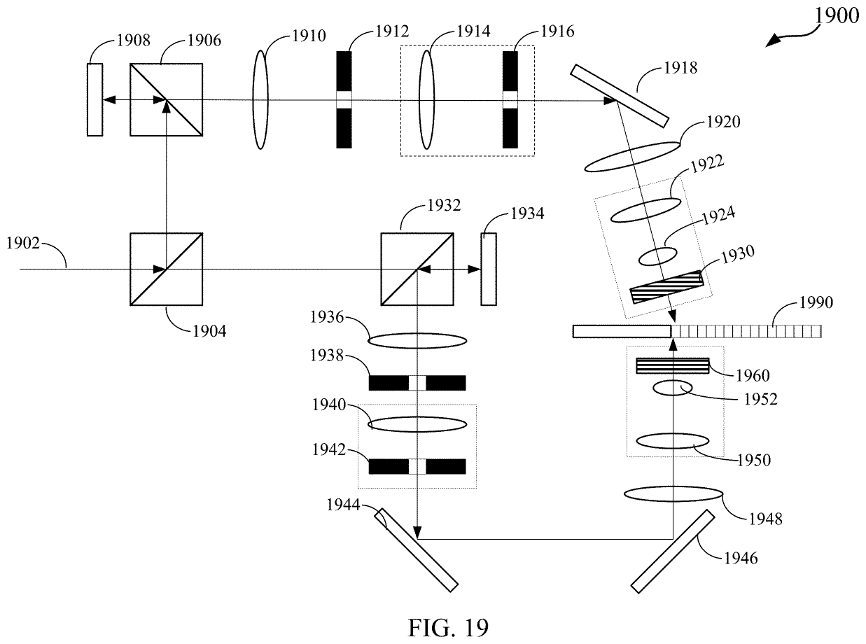

FIG. 19 includes a simplified block diagram of an example of a holographic printer 1900 according to certain embodiments. Holographic printer 1900 may include a beam splitter 1904 (e.g., a polarization beam splitter cube or any other beam splitter) that can split an input beam 1902 into two beams. Holographic printer 1900 may also include two sets of optical modulation, filtering, and demagnifying devices. Each set of optical modulation, filtering, and demagnifying devices may be used to condition one of the two beams from beam splitter 1904 to generate an object beam or a reference beam for holographic recording.

In the illustrated example, the first set of optical modulation, filtering, and demagnifying devices may include a beam splitter 1906, an SLM 1908, a lens 1910, a filter 1912, a lens 1914, a filter 1916, a reflector 1918 (e.g., a mirror), a lens 1920, a lens 1922, a lens 1924, and a beam steering device 1930 (e.g., any switchable grating stack described above). Any of the lenses described above may include a single lens or a lens assembly that includes a group of lenses. Lens 1922 and lens 1924 may form an objective lens that includes multiple lenses. In some embodiments, some of these devices may be optional. For example, as described above with respect to FIG. 6, in some embodiments, lens 1914 and filter 1916 may be optional; lens 1922 and lens 1924 may be optional; and beam steering device 1930 may be optional. In some embodiments, lens 1920 may be before or after reflector 1918.

Beam splitter 1906 may reflect the first beam to SLM 1908. SLM 1908 may receive data from a controller (e.g., controller 605) to implement a holographic fringe pattern (e.g., a CGH) corresponding to a hologram element. The first beam may be modulated by SLM 1908 such that the modulated first beam may have a desired wave-front. The modulated first beam reflected by SLM 1908 may be Fourier transformed by lens 1910 onto a Fourier plane. Undesired light, such as the high diffraction orders and/or the unmodulated 0th diffraction order, may be spatially filtered by filter 1912 at the Fourier plane, where only the first (±1) diffraction orders may be allowed to pass. For example, filter 1912 may include a DC filter (e.g., a chrome spot) that can filter out the 0th diffraction order, and/or a low-pass filter (e.g., an aperture) that can filter out the high diffraction orders. In some embodiments, lens 1914 and filter 1916 may be used, in combination with lens 1910 and filter 1912, to filter the first beam modulated by SLM 1908. As described above with respect to FIG. 6, the first beam filtered by filter 1912 and/or filter 1916 may be demagnified by one or more telecentric systems, such as a telecentric system including lens 1910 and lens 1914 or lens 1920, and/or a telecentric system including lens 1922 and lens 1924, where the focal lengths of the lenses may be selected such that the first beam may be demagnified. For example, lens 1924 may have a shorter focal length than lens 1922, and/or lens 1920 or 1914 may have a shorter focal length than lens 1910. The demagnified, filtered, and modulated wave-front of the first beam may optionally be steered by beam steering device 1930 to an area on a holographic material layer 1990.

Similarly, the second set of optical modulation, filtering, and demagnifying devices may include a beam splitter 1932, an SLM 1934, a lens 1936, a filter 1938, a lens 1940, a filter 1942, a reflector 1944 (e.g., a mirror or a prism), a reflector 1946 (e.g., a mirror or a prism), a lens 1948, a lens 1950, a lens 1952, and a beam steering device 1960 (e.g., any switching grating stack described above). Any of the lenses described above may include a single lens or a lens assembly that includes a group of lenses. Lens 1950 and lens 1952 may form an objective lens that includes multiple lenses. In some embodiments, some of these devices may be optional. For example, as described above with respect to FIG. 6, in some embodiments, lens 1940 and filter 1942 may be optional; lens 1950 and lens 1952 may be optional; and beam steering device 1960 may be optional. In some embodiments, lens 1948 may be before reflector 1944, between reflector 1944 and reflector 1946, or after reflector 1946.

Beam splitter 1932 may transmit the second beam to SLM 1934. SLM 1934 may receive data from a controller (e.g., controller 605) to implement a holographic fringe pattern (e.g., a CGH) corresponding to a hologram element. The second beam may be modulated by SLM 1934 such that the modulated second beam may have a desired wave-front. The modulated second beam may be reflected by SLM 1908 and beam splitter 1932, and may be Fourier transformed by lens 1936 onto a Fourier plane. Undesired light, such as high diffraction orders and/or the unmodulated 0th diffraction order, may be spatially filtered by filter 1938 at the Fourier plane, where only the first (±1) diffraction orders may be allowed to pass. For example, filter 1938 may include a DC filter (e.g., a chrome spot) that can filter out the 0th diffraction order, and/or a low-pass filter (e.g., an aperture) that can filter out the high diffraction orders. In some embodiments, lens 1940 and filter 1942 may be used, in combination with lens 1936 and filter 1938, to filter the second beam modulated by SLM 1934. As described above with respect to FIG. 6, the second beam filtered by filter 1912 and/or filter 1916 may be demagnified by one or more telecentric systems, such as a telecentric system including lens 1936 and lens 1940 or lens 1948, and/or a telecentric system including lens 1950 and lens 1952, where the focal lengths of the lenses may be selected such that the second beam may be demagnified. For example, lens 1952 may have a shorter focal length than lens 1950, and/or lens 1948 or 1940 may have a shorter focal length than lens 1936. The demagnified, filtered, and modulated wave-front of the second beam may optionally be steered by beam steering device 1960 to an area on holographic material layer 1990, where the second beam may interfere with the first beam to form a light fringe pattern and thus a hologram element.

To record the next hologram element, data for the next hologram element may be sent to SLM 1908 and/or SLM 1934, and holographic material layer 1990 may be moved to the next position by a motorized stage (e.g., 2D translation stage 685). After all hologram elements are recorded, holographic material layer 1990 may be processed, such as cured or bleached, to form the desired hologram.

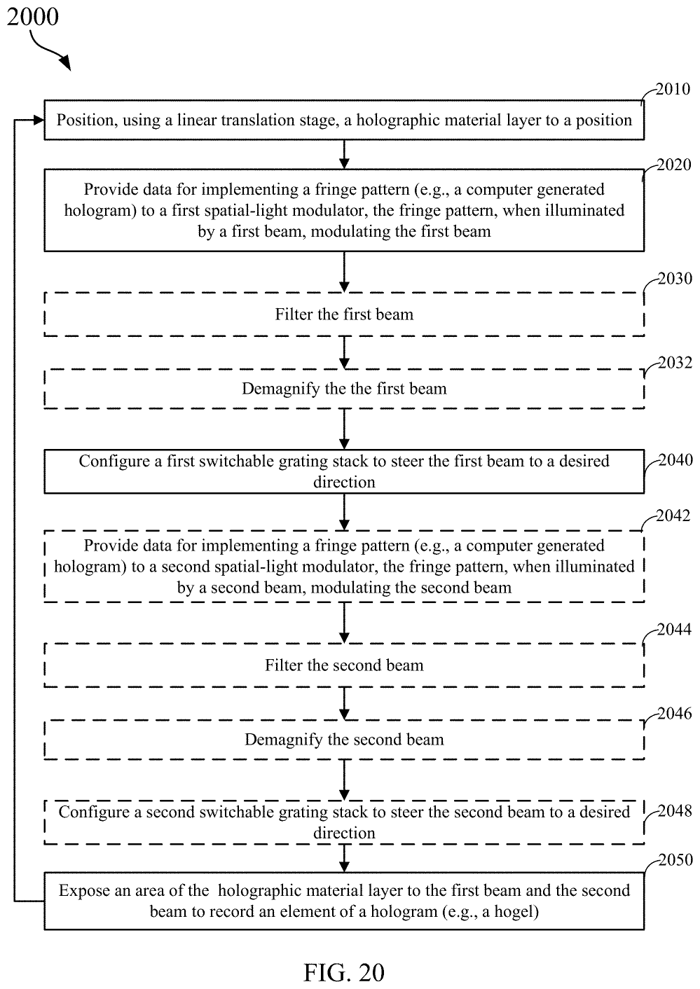

FIG. 20 is a simplified flowchart 2000 illustrating an example of a method of printing a holographic optical element according to certain embodiments. The operations described in flowchart 2000 are for illustration purposes only and are not intended to be limiting. In various implementations, modifications may be made to flowchart 2000 to add additional operations, omit some operations, combine some operations, split some operations, or reorder some operations. One or more computer systems may execute instructions stored on a non-transitory storage medium to control a holographic printing system (e.g., a holographic wave-front printer) to perform the method.

At block 2010, a computer system may control a linear translation stage that supports a holographic material layer (e.g., a photopolymer layer) to move the holographic layer to a desired position. At block 2020, the computer system may provide data for implementing a fringe pattern (e.g., a computer generated hologram) to a first spatial-light modulator. The fringe pattern implemented by the first SLM, when illuminated by a first beam, may modulate the first beam to generate a desired wave-front. Optionally, at block 2030, the first beam may be filtered, for example, at a Fourier plane by a DC filter and/or a low-pass filter to block the unmodulated zeroth diffraction order and high diffraction orders and to allow the ±1 diffraction orders to pass. Optionally, at block 2032, the first beam may be demagnified using, for example, one or more telecentric systems. At block 2040, the computer system may configure a first switchable grating stack as described above to steer the first beam to a desired direction. The first switchable grating stack may be configurable to steer the first beam to one of a plurality of directions.

Optionally, at block 2042, the computer system may provide data for implementing a fringe pattern (e.g., a computer generated hologram) to a second spatial-light modulator. The fringe pattern implemented by the second SLM, when illuminated by a second beam, may modulate the second beam to generate a desired wave-front. Optionally, at block 2044, the second beam may be filtered, for example, at a Fourier plane by a DC filter and/or a low-pass filter to block the unmodulated zeroth diffraction order and high diffraction orders and to allow the ±1 diffraction orders to pass. Optionally, at block 2046, the second beam may be demagnified using, for example, one or more telecentric systems. At block 2048, the computer system may configure a second switchable grating stack as described above to steer the second beam to a desired direction. The second switchable grating stack may be configurable to steer the second beam to one of a plurality of directions.

At block 2050, the computer system may control an exposure system to expose an area of the holographic material layer to the first beam and the second beam to record an element of a hologram (e.g., a hogel). The first beam and the second beam may interfere to generate a light fringe pattern, which may cause the polymerization and diffusion of the writing monomers to form a holographic optical element corresponding to the light fringe pattern as described above.

After the exposure, the computer system may control the 2D linear translation stage to move the holographic material layer to the next position, and the operations at blocks 2020-2050 may be performed again to record another element of the hologram at a different area of the holographic material layer. Operations at blocks 2010-2050 may be performed iteratively to record a 2D array of elements of the hologram. After all elements of the hologram are recorded, the holographic material layer may be post-processed, for example, for dye bleaching, completing polymerization, permanently fixing the recorded pattern, and enhancing the refractive index modulation.

Embodiments of the invention may be used to fabricate components of an artificial reality system or may be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMTD, a mobile device or computing system, or any other hardware platform capable of providing artificial reality content to one or more viewers.

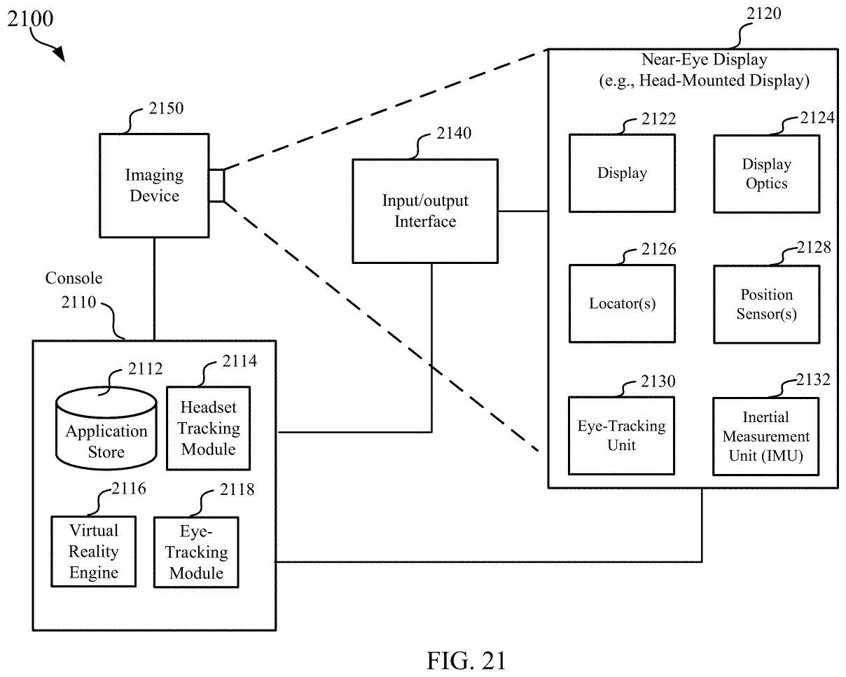

FIG. 21 is a simplified block diagram of an example of an artificial reality system environment 2100 including a near-eye display system 2120 that may use one or more holographic optical elements fabricated using techniques disclosed herein according certain embodiments. Artificial reality system environment 2100 shown in FIG. 21 may include near-eye display system 2120, an optional imaging device 2150, and an optional input/output interface 2140 that may each be coupled to an optional console 2110. While FIG. 21 shows example artificial reality system environment 2100 including one near-eye display system 2120, one imaging device 2150, and one input/output interface 2140, any number of these components may be included in artificial reality system environment 2100, or any of the components may be omitted. For example, there may be multiple near-eye display systems 2120 monitored by one or more external imaging devices 2150 in communication with console 2110. In some configurations, artificial reality system environment 2100 may not include imaging device 2150, optional input/output interface 2140, and optional console 2110. In alternative configurations, different or additional components may be included in artificial reality system environment 2100. In some configurations, near-eye display systems 2120 may include imaging device 2150, which may be used to track one or more input/output devices (e.g., input/output interface 2140), such as a handhold controller.

Near-eye display system 2120 may be a head-mounted display that presents content to a user. Examples of content presented by near-eye display system 2120 include one or more of images, videos, audios, or some combination thereof. In some embodiments, audios may be presented via an external device (e.g., speakers and/or headphones) that receives audio information from near-eye display system 2120, console 2110, or both, and presents audio data based on the audio information. Near-eye display system 2120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display system 2120 may be implemented in any suitable form factor, including a pair of glasses. Some embodiments of near-eye display system 2120 are further described below. Additionally, in various embodiments, the functionality described herein may be used in a headset that combines images of an environment external to near-eye display system 2120 and artificial reality content (e.g., computer-generated images). Therefore, near-eye display system 2120 may augment images of a physical, real-world environment external to near-eye display system 2120 with generated content (e.g., images, video, sound, etc.) to present an augmented reality to a user.

In various embodiments, near-eye display system 2120 may include one or more of display electronics 2122, display optics 2124, and an eye-tracking system 2130. In some embodiments, near-eye display system 2120 may also include one or more locators 2126, one or more position sensors 2128, and an inertial measurement unit (IMU) 2132. Near-eye display system 2120 may omit any of these elements or include additional elements in various embodiments. Additionally, in some embodiments, near-eye display system 2120 may include elements combining the function of various elements described in conjunction with FIG. 21.

Display 2122 may display or facilitate the display of images to the user according to data received from, for example, console 2110. In various embodiments, display 2122 may include one or more display panels, such as a holographic display, a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display system 2120, display 2122 may include a front TOLED panel, a rear display panel, and an optical component (e.g., an attenuator, polarizer, or diffractive or spectral film) between the front and rear display panels. Display 2122 may include pixels to emit light of a predominant color such as red, green, blue, white, or yellow. In some implementations, display 2122 may display a three-dimensional (3D) image through stereo effects produced by two-dimensional panels to create a subjective perception of image depth. For example, display 2122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 2124 may display image content optically (e.g., using optical waveguides and couplers), magnify image light received from display electronics 2122, correct optical errors associated with the image light, and present the corrected image light to a user of near-eye display system 2120. In various embodiments, display optics 2124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 2122. Display optics 2124 may include a combination of different optical elements as well as mechanical couplings to maintain relative spacing and orientation of the optical elements in the combination. One or more optical elements in display optics 2124 may have an optical coating, such as an anti-reflective coating, a reflective coating, a filtering coating, or a combination of different optical coatings.

Magnification of the image light by display optics 2124 may allow display 2122 to be physically smaller, weigh less, and consume less power than larger displays. Additionally, magnification may increase a field of view of the displayed content. The amount of magnification of image light by display optics 2124 may be changed by adjusting, adding, or removing optical elements from display optics 2124. In some embodiments, display optics 2124 may project displayed images to one or more image planes that may be further away from the user's eyes than near-eye display system 2120/

Display optics 2124 may also be designed to correct one or more types of optical errors, such as two-dimensional optical errors, three-dimensional optical errors, or a combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 2126 may be objects located in specific positions on near-eye display system 2120 relative to one another and relative to a reference point on near-eye display system 2120. In some implementations, console 2110 may identify locators 2126 in images captured by imaging device 2150 to determine the artificial reality headset's position, orientation, or both. A locator 2126 may be a light emitting diode (LED), a corner cube reflector, a reflective marker, a type of light source that contrasts with an environment in which near-eye display system 2120 operates, or some combinations thereof. In embodiments where locators 2126 are active components (e.g., LEDs or other types of light emitting devices), locators 2126 may emit light in the visible band (e.g., about 380 nm to 750 nm), in the infrared (IR) band (e.g., about 750 nm to 21 mm), in the ultraviolet band (e.g., about 210 nm to about 380 nm), in another portion of the electromagnetic spectrum, or in any combination of portions of the electromagnetic spectrum.

Imaging device 2150 may be part of near-eye display system 2120 or may be external to near-eye display system 2120. Imaging device 2150 may generate slow calibration data based on calibration parameters received from console 2110. Slow calibration data may include one or more images showing observed positions of locators 2126 that are detectable by imaging device 2150. Imaging device 2150 may include one or more cameras, one or more video cameras, any other device capable of capturing images including one or more of locators 2126, or some combinations thereof. Additionally, imaging device 2150 may include one or more filters (e.g., to increase signal to noise ratio). Imaging device 2150 may be configured to detect light emitted or reflected from locators 2126 in a field of view of imaging device 2150. In embodiments where locators 2126 include passive elements (e.g., retroreflectors), imaging device 2150 may include a light source that illuminates some or all of locators 2126, which may retro-reflect the light to the light source in imaging device 2150. Slow calibration data may be communicated from imaging device 2150 to console 2110, and imaging device 2150 may receive one or more calibration parameters from console 2110 to adjust one or more imaging parameters (e.g., focal length, focus, frame rate, sensor temperature, shutter speed, aperture, etc.).

Position sensors 2128 may generate one or more measurement signals in response to motion of near-eye display system 2120. Examples of position sensors 2128 may include accelerometers, gyroscopes, magnetometers, other motion-detecting or error-correcting sensors, or some combinations thereof. For example, in some embodiments, position sensors 2128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 2132 may be an electronic device that generates fast calibration data based on measurement signals received from one or more of position sensors 2128. Position sensors 2128 may be located external to IMU 2132, internal to IMU 2132, or some combination thereof. Based on the one or more measurement signals from one or more position sensors 2128, IMU 2132 may generate fast calibration data indicating an estimated position of near-eye display system 2120 relative to an initial position of near-eye display system 2120. For example, IMU 2132 may integrate measurement signals received from accelerometers over time to estimate a velocity vector and integrate the velocity vector over time to determine an estimated position of a reference point on near-eye display system 2120. Alternatively, IMU 2132 may provide the sampled measurement signals to console 2110, which may determine the fast calibration data. While the reference point may generally be defined as a point in space, in various embodiments, the reference point may also be defined as a point within near-eye display system 2120 (e.g., a center of IMU 2132).

Eye-tracking system 2130 may include one or more eye-tracking systems. Eye tracking may refer to determining an eye's position, including orientation and location of the eye, relative to near-eye display system 2120. An eye-tracking system may include an imaging system to image one or more eyes and may generally include a light emitter, which may generate light that is directed to an eye such that light reflected by the eye may be captured by the imaging system. For example, eye-tracking system 2130 may include a non-coherent or coherent light source (e.g., a laser diode) emitting light in the visible spectrum or infrared spectrum, and a camera capturing the light reflected by the user's eye. As another example, eye-tracking system 2130 may capture reflected radio waves emitted by a miniature radar unit. Eye-tracking system 2130 may use low-power light emitters that emit light at frequencies and intensities that would not injure the eye or cause physical discomfort. Eye-tracking system 2130 may be arranged to increase contrast in images of an eye captured by eye-tracking system 2130 while reducing the overall power consumed by eye-tracking system 2130 (e.g., reducing power consumed by a light emitter and an imaging system included in eye-tracking system 2130). For example, in some implementations, eye-tracking system 2130 may consume less than 2100 milliwatts of power.

Eye-tracking system 2130 may be configured to estimate the orientation of the user's eye. The orientation of the eye may correspond to the direction of the user's gaze within near-eye display system 2120. The orientation of the user's eye may be defined as the direction of the foveal axis, which is the axis between the fovea (an area on the retina of the eye with the highest concentration of photoreceptors) and the center of the eye's pupil. In general, when a user's eyes are fixed on a point, the foveal axes of the user's eyes intersect that point. The pupillary axis of an eye may be defined as the axis that passes through the center of the pupil and is perpendicular to the corneal surface. In general, even though the pupillary axis and the foveal axis intersect at the center of the pupil, the pupillary axis may not directly align with the foveal axis. For example, the orientation of the foveal axis may be offset from the pupillary axis by approximately −1° to 8° laterally and about ±4° vertically (which may be referred to as kappa angles, which may vary from person to person). Because the foveal axis is defined according to the fovea, which is located in the back of the eye, the foveal axis may be difficult or impossible to measure directly in some eye-tracking embodiments. Accordingly, in some embodiments, the orientation of the pupillary axis may be detected and the foveal axis may be estimated based on the detected pupillary axis.

Input/output interface 2140 may be a device that allows a user to send action requests to console 2110. An action request may be a request to perform a particular action. For example, an action request may be to start or to end an application or to perform a particular action within the application. Input/output interface 2140 may include one or more input devices. Example input devices may include a keyboard, a mouse, a game controller, a glove, a button, a touch screen, or any other suitable device for receiving action requests and communicating the received action requests to console 2110. An action request received by the input/output interface 2140 may be communicated to console 2110, which may perform an action corresponding to the requested action. In some embodiments, input/output interface 2140 may provide haptic feedback to the user in accordance with instructions received from console 2110. For example, input/output interface 2140 may provide haptic feedback when an action request is received, or when console 2110 has performed a requested action and communicates instructions to input/output interface 2140. In some embodiments, imaging device 2150 may be used to track input/output interface 2140, such as tracking the location or position of a controller (which may include, for example, an IR light source) or a hand of the user to determine the motion of the user. In some embodiments, near-eye display 2120 may include one or more imaging devices (e.g., imaging device 2150) to track input/output interface 2140, such as tracking the location or position of a controller or a hand of the user to determine the motion of the user.

Console 2110 may provide content to near-eye display system 2120 for presentation to the user in accordance with information received from one or more of imaging device 2150, near-eye display system 2120, and input/output interface 2140. In the example shown in FIG. 21, console 2110 may include an application store 2112, a headset tracking module 2114, an artificial reality engine 2116, and eye-tracking module 2118. Some embodiments of console 2110 may include different or additional modules than those described in conjunction with FIG. 21. Functions further described below may be distributed among components of console 2110 in a different manner than is described here.

In some embodiments, console 2110 may include a processor and a non-transitory computer-readable storage medium storing instructions executable by the processor. The processor may include multiple processing units executing instructions in parallel. The computer-readable storage medium may be any memory, such as a hard disk drive, a removable memory, or a solid-state drive (e.g., flash memory or dynamic random access memory (DRAM)). In various embodiments, the modules of console 2110 described in conjunction with FIG. 21 may be encoded as instructions in the non-transitory computer-readable storage medium that, when executed by the processor, cause the processor to perform the functions further described below.

Application store 2112 may store one or more applications for execution by console 2110. An application may include a group of instructions that, when executed by a processor, generates content for presentation to the user. Content generated by an application may be in response to inputs received from the user via movement of the user's eyes or inputs received from the input/output interface 2140. Examples of the applications may include gaming applications, conferencing applications, video playback application, or other suitable applications.

Headset tracking module 2114 may track movements of near-eye display system 2120 using slow calibration information from imaging device 2150. For example, headset tracking module 2114 may determine positions of a reference point of near-eye display system 2120 using observed locators from the slow calibration information and a model of near-eye display system 2120. Headset tracking module 2114 may also determine positions of a reference point of near-eye display system 2120 using position information from the fast calibration information. Additionally, in some embodiments, headset tracking module 2114 may use portions of the fast calibration information, the slow calibration information, or some combination thereof, to predict a future location of near-eye display system 2120. Headset tracking module 2114 may provide the estimated or predicted future position of near-eye display system 2120 to artificial reality engine 2116.

Headset tracking module 2114 may calibrate the artificial reality system environment 2100 using one or more calibration parameters, and may adjust one or more calibration parameters to reduce errors in determining the position of near-eye display system 2120. For example, headset tracking module 2114 may adjust the focus of imaging device 2150 to obtain a more accurate position for observed locators on near-eye display system 2120. Moreover, calibration performed by headset tracking module 2114 may also account for information received from IMU 2132. Additionally, if tracking of near-eye display system 2120 is lost (e.g., imaging device 2150 loses line of sight of at least a threshold number of locators 2126), headset tracking module 2114 may re-calibrate some or all of the calibration parameters.

Artificial reality engine 2116 may execute applications within artificial reality system environment 2100 and receive position information of near-eye display system 2120, acceleration information of near-eye display system 2120, velocity information of near-eye display system 2120, predicted future positions of near-eye display system 2120, or some combination thereof from headset tracking module 2114. Artificial reality engine 2116 may also receive estimated eye position and orientation information from eye-tracking module 2118. Based on the received information, artificial reality engine 2116 may determine content to provide to near-eye display system 2120 for presentation to the user. For example, if the received information indicates that the user has looked to the left, artificial reality engine 2116 may generate content for near-eye display system 2120 that reflects the user's eye movement in a virtual environment. Additionally, artificial reality engine 2116 may perform an action within an application executing on console 2110 in response to an action request received from input/output interface 2140, and provide feedback to the user indicating that the action has been performed. The feedback may be visual or audible feedback via near-eye display system 2120 or haptic feedback via input/output interface 2140.

Eye-tracking module 2118 may receive eye-tracking data from eye-tracking system 2130 and determine the position of the user's eye based on the eye-tracking data. The position of the eye may include an eye's orientation, location, or both relative to near-eye display system 2120 or any element thereof. Because the eye's axes of rotation change as a function of the eye's location in its socket, determining the eye's location in its socket may allow eye-tracking module 2118 to more accurately determine the eye's orientation.

In some embodiments, eye-tracking module 2118 may store a mapping between images captured by eye-tracking system 2130 and eye positions to determine a reference eye position from an image captured by eye-tracking system 2130. Alternatively or additionally, eye-tracking module 2118 may determine an updated eye position relative to a reference eye position by comparing an image from which the reference eye position is determined to an image from which the updated eye position is to be determined. Eye-tracking module 2118 may determine eye position using measurements from different imaging devices or other sensors. For example, eye-tracking module 2118 may use measurements from a slow eye-tracking system to determine a reference eye position, and then determine updated positions relative to the reference eye position from a fast eye-tracking system until a next reference eye position is determined based on measurements from the slow eye-tracking system.

Eye-tracking module 2118 may also determine eye calibration parameters to improve precision and accuracy of eye tracking. Eye calibration parameters may include parameters that may change whenever a user dons or adjusts near-eye display system 2120. Example eye calibration parameters may include an estimated distance between a component of eye-tracking system 2130 and one or more parts of the eye, such as the eye's center, pupil, cornea boundary, or a point on the surface of the eye. Other example eye calibration parameters may be specific to a particular user and may include an estimated average eye radius, an average corneal radius, an average sclera radius, a map of features on the eye surface, and an estimated eye surface contour. In embodiments where light from the outside of near-eye display system 2120 may reach the eye (as in some augmented reality applications), the calibration parameters may include correction factors for intensity and color balance due to variations in light from the outside of near-eye display system 2120. Eye-tracking module 2118 may use eye calibration parameters to determine whether the measurements captured by eye-tracking system 2130 would allow eye-tracking module 2118 to determine an accurate eye position (also referred to herein as “valid measurements”). Invalid measurements, from which eye-tracking module 2118 may not be able to determine an accurate eye position, may be caused by the user blinking, adjusting the headset, or removing the headset, and/or may be caused by near-eye display system 2120 experiencing greater than a threshold change in illumination due to external light. In some embodiments, at least some of the functions of eye-tracking module 2118 may be performed by eye-tracking system 2130.

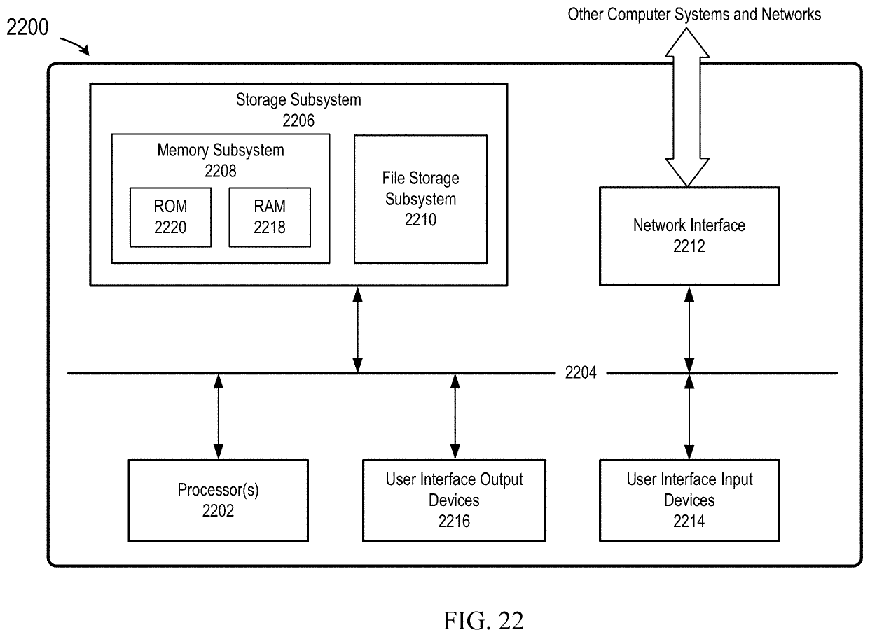

FIG. 22 illustrates an example of a computer system 2200 for implementing some of the embodiments disclosed herein. Computer system 2200 can be used to implement any of the controllers or computer systems discussed above. For example, computer system 2200 may be used to implement controller 605, linear translation stages, or some spatial-light modulators described herein. Computer system 2200 can include one or more processors 2202 that can communicate with a number of peripheral devices (e.g., input devices) via an internal bus subsystem 2204. These peripheral devices can include storage subsystem 2206 (comprising memory subsystem 2208 and file storage subsystem 2210), user interface input devices 2214, user interface output devices 2216, and a network interface subsystem 2212.

In some examples, internal bus subsystem 2204 can provide a mechanism for letting the various components and subsystems of computer system 2200 communicate with each other as intended. Although internal bus subsystem 2204 is shown schematically as a single bus, alternative embodiments of the bus subsystem can utilize multiple buses. Additionally, network interface subsystem 2212 can serve as an interface for communicating data between computer system 2200 and other computer systems or networks. Embodiments of network interface subsystem 2212 can include wired interfaces (e.g., Ethernet, RS-232, RS-485, etc.) or wireless interfaces (e.g., ZigBee, Wi-Fi, cellular, etc.).

In some cases, user interface input devices 2214 can include a keyboard, pointing devices (e.g., mouse, trackball, touchpad, etc.), a barcode scanner, a touch-screen incorporated into a display, audio input devices (e.g., voice recognition systems, microphones, etc.), Human Machine Interfaces (HMI) and other types of input devices. In general, use of the term “input device” is intended to include all possible types of devices and mechanisms for inputting information into computer system 2200. Additionally, user interface output devices 2216 can include a display subsystem, a printer, or non-visual displays such as audio output devices, etc. The display subsystem can be any known type of display device. In general, use of the term “output device” is intended to include all possible types of devices and mechanisms for outputting information from computer system 2200.

Storage subsystem 2206 can include memory subsystem 2208 and file storage subsystem 2210. Subsystems 2208 and 2210 represent non-transitory computer-readable storage media that can store program code and/or data that provide the functionality of disclosed herein. In some embodiments, memory subsystem 2208 can include a number of memories including main random access memory (RAM) 2218 for storage of instructions and data during program execution and read-only memory (ROM) 2220 in which fixed instructions may be stored. File storage subsystem 2210 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A holographic recording system comprising:
a linear translation stage configured to position a holographic material layer;
a light source configured to emit a laser beam;
a beam splitting subsystem configured to:
split the laser beam into a first light beam and a second light beam; and
direct the second light beam towards the holographic material layer;
a spatial-light modulator configured to implement a fringe pattern that modulates the first light beam to generate an object beam;
a demagnification optical subsystem configured to demagnify the object beam; and
a switchable grating stack configurable to direct the object beam to a set of directions towards the holographic material layer to interfere with the second light beam.

2. The holographic recording system of claim 1, wherein the object beam is characterized by a freeform wave-front.

3. The holographic recording system of claim 1, wherein the fringe pattern includes a computer-generated hologram.

4. The holographic recording system of claim 1, wherein the fringe pattern is configured to modulate at least one of a phase or an amplitude of the first light beam.

5. The holographic recording system of claim 1, wherein:
the switchable grating stack includes a plurality of polarization gratings arranged in a stack; and
each polarization grating in the plurality of polarization gratings is configurable to direct a right-handed circularly polarized light beam to a first direction and direct a left-handed circularly polarized light beam to a second direction.

6. The holographic recording system of claim 5, wherein the plurality of polarization gratings includes at least one of a right-handed circular polarization grating or a left-handed circular polarization grating.

7. The holographic recording system of claim 5, wherein the plurality of polarization gratings includes at least one of a polarization volume grating, a passive Pancharatnam-Berry phase (PBP) grating, or an active PBP grating.

8. The holographic recording system of claim 5, wherein each polarization grating in the plurality of polarization gratings is configurable to:
diffract the right-handed circularly polarized light beam to one of ±1 diffraction orders; and
diffract the left-handed circularly polarized light beam to another one of the ±1 diffraction orders.

9. The holographic recording system of claim 5, wherein each polarization grating in the plurality of polarization gratings is configured to:
diffract one of the right-handed circularly polarized light beam and the right-handed circularly polarized light beam to one of ±1 diffraction orders; and
maintain a propagation direction of another one of the right-handed circularly polarized light beam and the right-handed circularly polarized light beam.

10. The holographic recording system of claim 5, further comprising a plurality of switchable half-wave plates interleaved with the plurality of polarization gratings, wherein each of the plurality of switchable half-wave plates is configured to:
when switched on, convert a right-handed circularly polarized input beam into a left-handed circularly polarized output beam and convert a left-handed circularly polarized input beam into a right-handed circularly polarized beam; and
when switched off by a voltage signal, maintain a polarization state of an input beam.

11. The holographic recording system of claim 5, wherein each polarization grating in the plurality of polarization gratings is characterized by a different respective grating period.

12. The holographic recording system of claim 5, wherein:
the plurality of polarization gratings includes a plurality of active gratings; and
each active grating in the plurality of active gratings is configured to:
when switched on, diffract a circularly polarized light beam and change a polarization state of the circularly polarized light beam; and
when switched off by a voltage signal, maintain a propagation direction and a polarization state of an incident beam.

13. The holographic recording system of claim 1, further comprising:
a lens positioned with respect to the spatial-light modulator such that the spatial-light modulator is at a focal plane of the lens; and
a low-pass filter positioned at another focal plane of the lens and configured to filter the object beam.

14. The holographic recording system of claim 1, wherein the demagnification optical subsystem comprises a telecentric subsystem that includes two lenses characterized by different respective focal lengths.

15. The holographic recording system of claim 1, wherein the set of directions includes at least a direction characterized by an angle greater than 300 with respect to a surface normal direction of the switchable grating stack.

16. The holographic recording system of claim 1, further comprising:
a second spatial-light modulator configured to implement a second fringe pattern that modulates the second light beam; and
a second demagnification optical subsystem configured to demagnify the second light beam and direct the second light beam towards the holographic material layer.

17. The holographic recording system of claim 16, further comprising:
a lens positioned with respect to the second spatial-light modulator such that the second spatial-light modulator is at a focal plane of the lens; and
a low-pass filter positioned at another focal plane of the lens and configured to filter the second light beam.

18. A method of recording of a hologram element of a plurality of hologram elements of a hologram, the method comprising:
controlling a linear translation stage to position a holographic material layer on the linear translation stage to a first position;
providing data for implementing a fringe pattern to a spatial-light modulator, the fringe pattern, when illuminated by a collimated light beam, generating an object beam;
filtering the object beam;
demagnifying the object beam;
configuring a switchable grating stack to steer the object beam to a direction of a set of discrete directions; and
exposing an area of the holographic material layer to the object beam and a reference beam to form the hologram element.

19. The method of claim 18, further comprising:
providing data for implementing a second fringe pattern to a second spatial-light modulator, the second fringe pattern, when illuminated by a second collimated light beam, generating the reference beam;
filtering the reference beam; and
demagnifying the reference beam.

20. The method of claim 18, wherein:
the switchable grating stack includes a plurality of polarization gratings and a plurality of switchable half-wave plates arranged in a stack; and
each polarization grating in the plurality of polarization gratings is configurable to direct a right-handed circularly polarized light beam to a first direction and direct a left-handed circularly polarized light beam to a second direction.
